(19) United States
(12) Patent Application Publication
(10) Pub. No.: US 2026/0277763 A1
(43) Pub. Date: Sep. 17, 2026

(54) SYSTEM

(71) Applicant: SoftBank Group Corp., Tokyo (JP)

(72) Inventor: Mikio YAGI, Tokyo (JP)

(73) Assignee: SoftBank Group Corp., Tokyo (JP)

(21) Appl. No.: 19/551,617

(22) Filed: Feb. 27, 2026

Related U.S. Application Data
(60) Provisional application No. 63/770,697, filed on Mar. 12, 2025.

(51) Int. Cl. G06F 11/34; G06F 11/30

(52) U.S. Cl. CPC G06F 11/3419; G06F 11/3058

(57) ABSTRACT

A system includes a processor configured to collect, in real time, environmental data within a data center from a plurality of sensors including temperature sensors, humidity sensors, power meters, and sensors monitoring operation of a cooling apparatus. The processor transmits the collected data to a cloud database for storage and analyzes accumulated data to learn an operation pattern of the data center. The processor acquires external climate data and energy market information from external data sources and integrates the external data with the accumulated data. Based on analysis of the accumulated data and the external climate and energy market information, the processor proposes an optimal operation method for the data center and notifies a data center administrator of the optimal operation method via a notification interface.

### CROSS-REFERENCE TO RELATED APPLICATION

This application claims the benefit of U.S. Provisional Application No. 63/770,697 filed on Mar. 12, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional data center management systems typically treat cooling control, energy consumption monitoring, and external condition awareness as separate functions, resulting in suboptimal overall energy efficiency and limited responsiveness to rapidly changing operating conditions. For example, many systems rely on fixed cooling setpoints or manually tuned control parameters that do not adapt in real time to variations in server load, internal thermal distribution, or external climate conditions. In addition, those systems often fail to incorporate dynamic energy market information, and thus cannot effectively shift loads or adjust cooling strategies in response to fluctuating electricity prices. Furthermore, existing solutions generally lack an integrated mechanism to learn operation patterns over time and to predict peak energy consumption or required cooling timings using machine learning, which leads to reactive rather than proactive operation. Still further, administrators frequently receive fragmented or delayed information that does not translate into concrete, system-level recommendations for coordinated adjustment of both cooling and power supply. As a result, energy consumption and associated carbon dioxide emissions remain higher than necessary, and the operational risk associated with thermal anomalies or improper cooling distribution is not adequately mitigated. Accordingly, there is a need for a system that can collect internal environmental data in real time, integrate such data with external climate data and energy market information, analyze the integrated data using machine learning to predict future conditions, and provide actionable, optimized operation methods to data center administrators through an intuitive interface, thereby improving energy efficiency, reducing environmental impact, and enhancing operational reliability.

### SUMMARY

In order to solve the foregoing problems, the present invention provides a system comprising a processor, wherein the processor is configured to collect, in real time, environmental data within a data center from a plurality of sensors including at least temperature sensors, humidity sensors, power meters, and sensors for monitoring an operating state of a cooling apparatus; transmit the collected environmental data to a database on a cloud and store the collected environmental data in the database; analyze data accumulated in the database to learn an operation pattern of the data center; acquire external climate data and energy market information from one or more external data sources and integrate the external climate data and the energy market information with the accumulated data; and propose an optimal operation method for the data center based on an analysis result of the accumulated data and the external climate data and the energy market information and notify an administrator of the data center of the optimal operation method via a notification interface. In one aspect, the processor is configured to compare past operation data of the data center with current environmental data using machine learning, construct a model that predicts at least a peak time of energy consumption and a timing at which cooling is required, dynamically update the model, and propose the optimal operation method in accordance with characteristics of the data center and changes in an external environment based on the dynamically updated model. In another aspect, the processor is configured to notify the administrator of the data center of the proposed optimal operation method via a dedicated management dashboard and enable the administrator to adjust at least a cooling system and a power supply of the data center based on the proposed optimal operation method, thereby reducing energy consumption and reducing carbon dioxide emissions. By virtue of these configurations, the system integrates internal sensor data, external climate and market data, and machine learning-based prediction and optimization into a unified control and recommendation framework that enhances energy efficiency, reduces environmental impact, and supports timely and informed decision-making by the administrator.

The term “system” refers to an arrangement of hardware and software components, including at least one processor and associated devices, that cooperate to perform the functions recited in the claims.

The term “processor” refers to one or more hardware-based processing units, such as a central processing unit (CPU), microcontroller, or other computation device, that execute instructions to perform data collection, analysis, communication, and control operations as recited in the claims. The term “data center” refers to a facility that houses multiple information technology resources including servers, storage devices, networking equipment, and associated infrastructure, and that requires environmental control such as cooling and power supply management.

The term “environmental data” refers to data representing physical conditions within the data center, including at least temperature, humidity, electrical power consumption, and operating states of cooling apparatuses.

The term “real time” refers to processing or data collection that is performed with a latency sufficiently short that the resulting information can be used for immediate or near-immediate control or decision-making in current operating conditions of the data center.

The term “sensor” refers to a device that measures a physical quantity, such as temperature, humidity, electrical power, fluid flow, or pressure, and outputs a corresponding electronic signal or data value.

The term “temperature sensor” refers to a sensor configured to measure temperature at a location in the data center, such as at a rack inlet, rack outlet, room area, or cooling apparatus component. The term “humidity sensor” refers to a sensor configured to measure relative humidity or absolute humidity of air within the data center.

The term “power meter” refers to a measurement device configured to measure electrical parameters, including at least power consumption, of equipment or a circuit within the data center. The term “sensor for monitoring an operating state of a cooling apparatus” refers to a sensor configured to detect one or more operating conditions of a cooling system, including at least coolant flow rate, coolant pressure, or on/off or load state of cooling equipment.

The term “cooling apparatus” refers to equipment that removes heat from the data center, including but not limited to air conditioners, chillers, cooling towers, in-row coolers, or liquid cooling systems.

The term “database” refers to an organized collection of data stored in a memory or storage device, managed by a database management system, and accessible by the processor for storing, querying, and updating environmental and related data.

The term “cloud” refers to a network-based computing environment in which computing resources, including databases and processing functions, are provided over a network infrastructure and are accessible remotely by the processor.

The term “accumulated data” refers to data that has been collected over time and stored in the database, including historical environmental data, external climate data, and energy market information.

The term “operation pattern of the data center” refers to a temporal or statistical profile of how the data center operates over time, including variations in power consumption, temperature, cooling demand, and other operational parameters.

The term “external climate data” refers to data representing environmental conditions outside the data center facility, including at least outside temperature, outside humidity, and optionally wind speed or other meteorological parameters.

The term “energy market information” refers to data related to the cost or availability of electrical energy, including at least current electricity prices, forecasted prices, or tariff information. The term “external data source” refers to a system or service outside the data center that provides external climate data or energy market information, typically via a communication interface or application programming interface.

The term “integrate” refers to the process of combining different sets of data, such as internal environmental data, external climate data, and energy market information, into a unified data set or model for joint analysis.

The term “optimal operation method” refers to a set of operational configurations or control strategies for the data center, including at least cooling and power supply settings, that are selected to improve performance metrics such as energy efficiency, operational reliability, cost, or environmental impact.

The term “analysis result” refers to information or output generated by the processor after processing and interpreting accumulated data and external data, including predictions, detections, classifications, or recommended actions.

The term “notification interface” refers to a hardware and/or software mechanism through which the processor provides information or recommendations to an administrator, such as a graphical user interface, web dashboard, or messaging system.

The term “administrator of the data center” refers to a human operator or responsible person who supervises, configures, or manages the operation of the data center, including cooling and power systems.

The term “machine learning” refers to a class of computational techniques in which models are trained on data to learn patterns or relationships, and subsequently used to make predictions, classifications, or decisions without being explicitly programmed with all rules.

The term “past operation data” refers to historical information regarding the operation of the data center, including past values of environmental data, workloads, cooling settings, and power usage. The term “current environmental data” refers to environmental data measured at or near the present time within the data center and used for real-time or near-real-time analysis and control. The term “model” refers to a mathematical, statistical, or computational representation, including a machine-learned representation, that maps input data to outputs such as predicted peak times, required cooling timings, or recommended operating parameters.

The term “peak time of energy consumption” refers to a time period in which energy consumption of the data center is predicted or observed to reach a relatively high level compared to other times in a given analysis window.

The term “timing at which cooling is required” refers to a predicted or determined point in time when cooling demand is expected to increase or when adjustments to cooling settings are necessary to maintain acceptable environmental conditions.

The term “dynamically update” refers to modifying or retraining a model over time using new data so that the model reflects recent changes in data center operation or external conditions.

The term “characteristics of the data center” refers to inherent or configured properties of the data center, including hardware layout, cooling infrastructure, workload patterns, thermal behavior, and operational policies.

The term “changes in an external environment” refers to variations over time in conditions external to the data center, including at least changes in outside climate and changes in energy market conditions.

The term “dedicated management dashboard” refers to a user interface, typically graphical and provided via a network-connected terminal, that is specifically designed to present monitoring information and operational recommendations for the data center.

The term “cooling system” refers to a set of components, including cooling apparatuses, control devices, and associated infrastructure, configured to manage and remove heat from the data center environment.

The term “power supply” refers to the infrastructure and equipment that provide electrical energy to the data center, including utility connections, distribution systems, uninterruptible power supplies, and related control equipment.

The term “carbon dioxide emissions” refers to emissions of CO2 associated with the production and consumption of energy used to operate the data center, including emissions indirectly caused by electricity usage.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

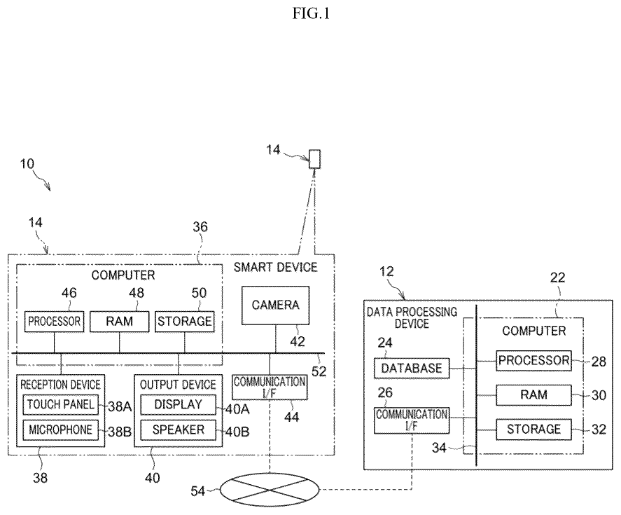

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

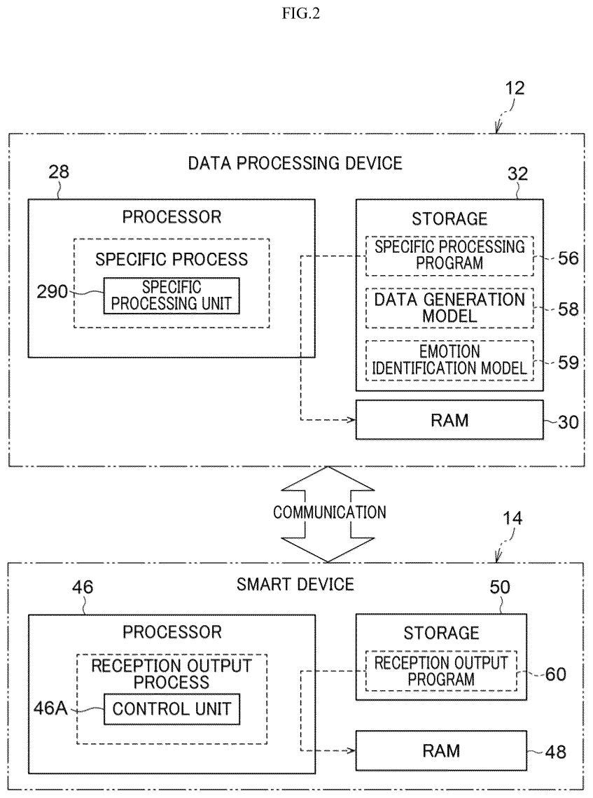

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional data center cooling and energy optimization systems rely primarily on fixed rule sets or conventional predictive models that operate on preprocessed telemetry. These systems typically ingest sensor data, perform threshold checks, and in some cases apply machine learning models to estimate future energy consumption or thermal conditions. However, such systems exhibit several technical limitations from the standpoint of computer technology.

First, conventional architectures treat prediction and human decision support as largely separate processes. Predictive models output numerical set-points or alarms, and human operators must manually interpret these outputs, reconcile them with external constraints such as dynamic energy pricing and weather forecasts, and then derive an operational plan. This causes fragmented data flows and manual reasoning steps that cannot be directly represented or optimized within the computing system. As a result, the processor cannot consistently transform heterogeneous data (time-series telemetry, external market data, operator constraints) into a coherent, machine-checkable operational policy without substantial human intervention.

Second, conventional systems lack an integrated mechanism to generate, validate, and refine natural-language operational strategies within the computational loop itself. Even when large language models or generative AI models are used, they are typically invoked as external advisory tools. Their outputs are not systematically grounded in the system's internal numerical predictions, nor are they automatically checked against safety constraints and infrastructure limits. This leads to a technical problem in that the processor cannot automatically reconcile generative natural-language recommendations with quantitative predictive results and encoded safety constraints, which reduces reliability and makes automated control impractical.

Third, the interaction between operators and optimization logic is often rigid and parameter-based. Operators must manipulate abstract configuration parameters, scripts, or rule files, which requires specialized expertise and introduces configuration errors. There is no unified mechanism for the system to accept high-level operator intent expressed in natural language, convert that intent into machine-interpretable constraints, and then integrate such constraints into the continuous optimization loop. Consequently, the underlying computing system cannot fully leverage human domain knowledge or rapidly adapt to changing operational policies without costly engineering effort.

Fourth, conventional telemetry processing pipelines typically handle data validation, anomaly detection, external data correlation, and recommendation presentation as loosely coupled modules. This fragmented design can cause inconsistencies between what the predictive model assumes, what the operator sees, and what the control subsystem executes. From a computer-technical standpoint, the lack of a unified representation of (i) validated time-series sensor data, (ii) external weather and price data, (iii) predicted future states, and (iv) natural-language policies hampers systematic optimization and auditability within the processor.

Accordingly, there is a need for an improved computer-implemented system and method in which a processor: (i) continuously ingests and normalizes environmental and external data; (ii) executes statistical and machine learning algorithms to derive numerical operational conditions; (iii) automatically constructs structured prompt sentences that summarize current and predicted states and constraints; (iv) invokes a generative AI model in a programmatic manner; (v) formally reconciles the natural-language operational policies returned by the generative AI model with the numerically computed operational conditions under explicit safety and constraint rules; and (vi) exposes these reconciled, integrated operational conditions to a user through a terminal that also supports natural-language input. Such a system improves the functioning of the computer itself by providing a closed-loop architecture that combines predictive analytics, generative reasoning, constraint checking, and operator interaction in a single, coherent processing pipeline, thereby enabling more reliable, explainable, and adaptive control of data center cooling and energy management.

The specific processing by the specific processing unit 290 of the data processing device 12 in Example 1 is realized by the following means.

The present invention provides a server comprising a processor and a memory storing instructions, wherein the processor is configured to execute the instructions to: receive, via a communication network, environmental information including temperature information, humidity information, power information, flow information, and pressure information from one or more information acquisition devices in a facility; validate the environmental information based on identification information and time information included in the environmental information; remove abnormal values from the environmental information; standardize the environmental information; and store the standardized environmental information as time-series information in a storage; acquire, via the communication network, external information including weather information and price information from one or more external information providing devices; align the external information with the time-series information on a common time axis; and store the external information in the storage in an integrated manner with the time-series information; analyze, based on the time-series information and the external information stored in the storage, future values of power consumption information and temperature information by performing statistical processing and machine learning processing; and numerically calculate operational conditions including operation conditions of cooling equipment and load distribution conditions of an information processing device group; generate, based on the time-series information, the operational conditions, and the external information, explanatory information summarizing a current and predicted operational state; generate a natural-language instruction sentence from the explanatory information; and construct inquiry information including the instruction sentence as a structured prompt sentence to be input to a generative AI model; transmit the prompt sentence to the generative AI model; obtain, from the generative AI model, operational policy information expressed in natural language; compare the numerically calculated operational conditions with the operational policy information; determine consistency between the numerically calculated operational conditions and the operational policy information based on safety conditions and constraint conditions; and generate integrated operational conditions by correcting or invalidating conflicting operational conditions; generate display information including the integrated operational conditions and the operational policy information; transmit the display information to a user terminal; receive, from the user terminal, operation information indicating acceptance or modification of the integrated operational conditions; and, based on the operation information, output control information corresponding to the integrated operational conditions to at least one of a building facility management device and a cooling facility control device and store a result of the output control information as history information in the storage. This enables a computer system to implement an integrated, closed-loop optimization pipeline in which numerical predictive models and generative AI models are programmatically combined under explicit safety and constraint checks, thereby improving the technical functioning of the server in processing heterogeneous telemetry and policy data, reducing operator burden in generating and validating operational plans, and enhancing the stability, adaptability, and explainability of automated cooling and energy management control.

The term “processor” refers to a hardware arithmetic and logic unit, such as a central processing unit or a group of processing cores, that executes instructions stored in a memory to perform data processing, control, and communication functions of the system.

The term “memory” refers to a non-transitory computer-readable storage medium, such as a semiconductor memory, magnetic storage, or optical storage, that stores instructions and data for execution and use by the processor.

The term “communication network” refers to a wired or wireless communication infrastructure, such as a local area network, wide area network, or the Internet, used to exchange data between the server, information acquisition devices, external information providing devices, user terminals, and control devices.

The term “information acquisition device” refers to an apparatus including at least one sensor or measurement unit configured to obtain environmental information, such as temperature, humidity, power, flow, or pressure, within a facility and to transmit the environmental information to the server.

The term “environmental information” refers to data representing physical conditions in a facility, including but not limited to temperature information, humidity information, power information, flow information, and pressure information obtained from one or more information acquisition devices.

The term “temperature information” refers to data values representing a thermal condition, such as air or device temperature, measured at one or more locations within a facility.

The term “humidity information” refers to data values representing a moisture level, such as relative humidity or absolute humidity, measured at one or more locations within a facility. The term “power information” refers to data values representing electrical characteristics, including at least one of power consumption, current, and voltage associated with equipment operating within a facility.

The term “flow information” refers to data values representing movement of a fluid, such as air flow rate or coolant flow rate, associated with a cooling path or duct within a facility.

The term “pressure information” refers to data values representing a pressure level, such as air pressure or fluid pressure, measured at one or more points in a cooling or airflow system within a facility.

The term “identification information” refers to data that uniquely or logically identifies a sensor, device, measurement point, or data source, such as an identifier, label, or address included in the environmental information.

The term “time information” refers to data indicating a time associated with a measurement or event, such as a timestamp or time index included in the environmental information or external information.

The term “abnormal value” refers to a data value that is determined to be erroneous, inconsistent, or outside a permissible range based on one or more criteria, such as physical plausibility, statistical deviation, or configuration rules.

The term “standardize” refers to processing that converts data into a common format, scale, unit, or representation, including at least one of unit conversion, normalization, rounding, and ordering on a unified time axis.

The term “time-series information” refers to data arranged as a sequence of values indexed by time, representing the evolution of environmental information or external information over multiple time points.

The term “storage” refers to a logical or physical data repository, such as a database, file system, or time-series store, in the memory or another storage device in which time-series information, external information, models, and history information are stored.

The term “external information” refers to data obtained from an external information providing device outside the facility, including at least weather information and price information relevant to operation of the facility.

The term “external information providing device” refers to a remote server or data service that supplies external information, such as weather data or market price data, to the server via the communication network.

The term “weather information” refers to data values representing environmental conditions outside the facility, such as outdoor temperature, outdoor humidity, wind speed, or similar meteorological parameters.

The term “price information” refers to data values representing a cost or tariff associated with energy or other resources, including at least energy price schedules or time-varying electricity rates. The term “statistical processing” refers to computational procedures that derive aggregate or analytical metrics from data, such as averages, variances, correlations, or trend analyses, executed by the processor.

The term “machine learning processing” refers to computational procedures in which the processor trains or applies a model that learns from data, such as a regression model, classification model, or time-series forecasting model, to predict or infer future values or patterns.

The term “power consumption information” refers to data representing the amount of electrical power used by equipment or subsystems in the facility over time.

The term “operational conditions” refers to one or more parameters or settings that define how equipment in the facility should operate, including at least operation conditions of cooling equipment and load distribution conditions of an information processing device group.

The term “operation conditions of cooling equipment” refers to parameters controlling cooling devices, such as set-point temperatures, fan speeds, flow rates, operating schedules, or on/off states for cooling equipment.

The term “information processing device group” refers to a collection of computing or data processing devices, such as servers or processing units, whose workloads or operating parameters can be adjusted or distributed.

The term “load distribution conditions” refers to parameters that specify how computational or electrical load is allocated among devices in the information processing device group, including distribution of tasks, power capping, or server allocation.

The term “explanatory information” refers to data generated by the processor that summarizes or describes the current and predicted operational state in an interpretable form, suitable for conversion into natural-language text.

The term “instruction sentence” refers to a natural-language sentence describing operations, constraints, or objectives to be considered by a generative AI model, derived from explanatory information.

The term “prompt sentence” refers to a structured natural-language text that includes at least one instruction sentence and is provided as an input query to a generative AI model to obtain a response.

The term “generative AI model” refers to a machine-learned model, such as a large language model, configured to generate natural-language text or other content in response to input text, including a prompt sentence.

The term “inquiry information” refers to data constructed by the processor, including at least a prompt sentence, that is transmitted to a generative AI model as a query to request generation of operational policy information.

The term “operational policy information” refers to information expressed in natural language by the generative AI model indicating strategies, guidelines, or recommendations for operation of equipment or systems under specified conditions.

The term “safety conditions” refers to constraints representing safe operating limits or rules, such as maximum permissible temperatures, minimum airflow, or equipment operating boundaries, enforced by the processor when evaluating operational conditions.

The term “constraint conditions” refers to operational, contractual, or technical limits, such as capacity limits, time windows, pricing thresholds, or service-level requirements, against which operational conditions and policies are evaluated.

The term “integrated operational conditions” refers to a set of operational conditions generated by the processor after reconciling numerically calculated operational conditions with operational policy information from the generative AI model under safety conditions and constraint conditions. The term “display information” refers to data generated by the processor that specifies content to be shown on a user interface, including at least integrated operational conditions, operational policy information, and related explanatory data.

The term “user terminal” refers to an apparatus, such as a workstation, client computer, or mobile device, including a display and input interface that allows a user to view display information and input operation information.

The term “operation information” refers to data indicating a user's decision or instruction regarding integrated operational conditions, including acceptance, rejection, or modification of one or more operational conditions.

The term “building facility management device” refers to a control system or controller that manages building infrastructure, such as power distribution, ventilation, or environmental systems. The term “cooling facility control device” refers to a control system or controller that directly manages cooling equipment, such as chillers, air handling units, or fans, based on received control information.

The term “control information” refers to data messages or commands generated by the processor to cause the building facility management device or cooling facility control device to change one or more operating parameters according to integrated operational conditions.

The term “history information” refers to records stored in the storage that describe past control actions, operational conditions, and associated outcomes, for later analysis, auditing, or model improvement.

The term “condition information” refers to a set of parameters or constraints included in a prompt sentence, such as past environmental information, prediction information, a temperature upper limit, and an allowable power consumption amount, that define requirements for the generative AI model.

The term “prediction information” refers to data representing estimated future states, such as predicted power consumption or temperature values, derived from statistical processing or machine learning processing by the processor.

The term “setting values” refers to specific numeric or symbolic parameters to be applied to equipment, such as target temperatures, fan speeds, or load levels, for particular time periods. The term “response information” refers to output generated by the generative AI model in response to a prompt sentence, expressed in natural language and including at least setting values, load distribution, and explanation information.

The term “free-description question sentence” refers to a question expressed in natural language by a user without being constrained to a predefined template, used to request analysis or proposals from the generative AI model.

The term “instruction sentence in natural language by a user” refers to a command or request expressed in human language by a user to specify desired objectives, constraints, or changes to operational conditions.

The term “input screen” refers to a user interface display region on the user terminal that allows a user to enter or edit a prompt sentence or other natural-language text to be sent to the generative AI model.

The term “server” refers to a computing apparatus including at least the processor and the memory, configured to perform data acquisition, analysis, interaction with a generative AI model, and control output as described in the claims.

In one embodiment, a server, a terminal, and one or more control devices are interconnected via a communication network to implement the claimed system. The server includes at least one processor and at least one memory storing instructions and data structures. The terminal includes a display and an input interface operated by a user. The control devices include a building facility management device and a cooling facility control device that directly drive actuators such as fans, pumps, and chillers in a physical data center facility.

The server executes an operating system such as a general-purpose server operating system (for example, a UNIX-like operating system) and application software implemented, for example, in a high-level language such as a scripting language or a compiled language. The server uses a relational database management system, such as a SQL-based database, or a time-series database, to store time-series information, external information, models, and history information. The server optionally uses a container orchestration platform for deployment and scaling of microservices implementing the respective functional components.

The server receives environmental information from information acquisition devices deployed in a facility that includes a plurality of computing devices, racks, air handling units, and power distribution units. The information acquisition devices include sensors such as temperature sensors, humidity sensors, power meters, flow sensors, and pressure sensors. The server communicates with the information acquisition devices through an industrial protocol such as a message queuing protocol or a fieldbus over IP. Each data record transmitted from the information acquisition devices includes identification information, time information, and at least one measured value. The server stores incoming environmental information in a memory buffer and performs validation processing. The server checks that the identification information matches a registered sensor identifier in a configuration table, that the time information conforms to an expected timestamp format, and that the measured value falls within a physically reasonable range defined for the corresponding sensor type. The server detects abnormal values such as missing fields, values outside a configured range, or values that deviate by more than a threshold number of standard deviations from a recent rolling mean.

The server removes or flags abnormal values and standardizes the remaining values. The server converts units to a unified unit system, normalizes values if required, and aligns measurements on a uniform time grid. For example, the server rounds timestamps to a fixed interval (e.g., 60 seconds) and aggregates multiple measurements within the same interval by computing an average or another aggregation function. The server then creates time-series information records, each record containing at least a time index, a normalized measured value, and a logical location identifier such as a rack identifier or zone identifier. The server writes the time-series information into structured tables in a storage, enabling indexed retrieval by time, location, and metric type. The server acquires external information from external information providing devices. The external information providing devices include remote services that supply weather information and price information. The server periodically issues requests over the communication network to obtain data representing external temperature, humidity, wind speed, and time-varying energy prices. The server receives the external information as structured messages, converts the external timestamps to a common time zone, and aligns the external information with the internal time-series information on a shared time axis. The server stores the aligned external information in the same storage in association with the time-series information.

The server constructs feature vectors for use in statistical processing and machine learning processing. The server retrieves time-series information and external information for a selected time window and computes derived quantities. The server calculates rolling averages, rolling variances, temporal gradients, correlations between power and temperature, and indicators such as total power consumption per room or per rack row. The server encodes external information, such as forecasted energy prices and external temperature, into time-aligned numerical features. The server stores these feature vectors in a feature store table, tagging each vector with metadata indicating its time index and whether it belongs to a training, validation, or inference set. The server implements machine learning processing using frameworks such as a tensor-based numerical library or a statistical learning library. In one embodiment, the server trains a time-series forecasting model implemented as a recurrent neural network or a temporal convolutional neural network. The server defines an architecture in which an input layer receives a sequence of feature vectors corresponding to past time steps, one or more hidden layers process the temporal sequence using gated recurrent units or convolutional filters, and an output layer produces predicted future values of power consumption information and temperature information at multiple future time steps.

The server defines a loss function such as a mean squared error between predicted and actual values and uses an optimization algorithm such as stochastic gradient descent with adaptive learning rate to update the model parameters. The server iteratively processes mini-batches of training sequences, computes forward passes to generate predictions, computes gradients of the loss function with respect to the model weights, and updates the weights using the optimization algorithm. The server monitors validation loss to prevent overfitting and stores trained model parameters in the storage along with model version identifiers.

The server also trains models for anomaly detection. In one embodiment, the server trains an autoencoder neural network that receives a feature vector representing a short time window of environmental information and external information and outputs a reconstruction of the same vector. The server minimizes a reconstruction error metric such as mean absolute error during training. During operation, the server computes reconstruction errors for new feature vectors and treats vectors with reconstruction errors exceeding a threshold as anomalies. This internal processing enables the server to detect subtle abnormal conditions that may not be captured by simple threshold rules.

The server further trains or uses a classification or regression model such as a gradient boosting tree ensemble to map features including internal sensor metrics and external price signals to recommended operating set-points, such as target supply air temperatures, fan speed levels, or time-shifted workload allocations. The server thereby computes operational conditions comprising operation conditions of cooling equipment and load distribution conditions of an information processing device group. Because the server encodes both internal environmental dynamics and external market conditions into the feature vectors, the resulting operational conditions correspond to an optimized balance between thermal safety and cost efficiency.

The server generates explanatory information summarizing the current and predicted operational state. The server compiles time-series summaries, predicted peak intervals, expected temperature ranges, and relevant constraints such as maximum allowable rack inlet temperature and maximum allowable power consumption. The server transforms these elements into structured internal representations, for example, structured records including key-value pairs that describe conditions and objectives.

The server then constructs a prompt sentence to be input to a generative AI model. The server converts the explanatory information into a natural-language instruction sentence containing a clear description of the current state, predicted behavior, constraints, and desired optimization goal. For example, the server generates prompt sentences such as:

“Current average rack inlet temperature is 26.5 degrees Celsius and is predicted to reach 28.0 degrees Celsius between 18:00 and 20:00. Outside air temperature is forecasted to drop below 10 degrees Celsius after 22:00. Electricity prices are forecasted to be highest between 18:00 and 21:00. Please propose an optimized cooling and load scheduling plan for the next 12 hours that minimizes energy cost while keeping rack inlet temperatures below 27 degrees Celsius. Output a step-by-step timetable with set-points and justification.”

In another example, the server generates a prompt sentence such as:

“Based on historical operation data of the data center, please construct a cooling and load scheduling strategy that reduces total energy consumption by at least 10 percent compared to the last 7 days while maintaining rack inlet temperatures below 26 degrees Celsius. Assume dynamic electricity prices and outside temperature forecasts are given, and provide three alternative strategies with pros and cons.”

The server composes inquiry information containing the prompt sentence and transmits the inquiry information to a generative AI model. The generative AI model may be implemented in a separate computing environment and may be a large language model pre-trained on natural language and optionally fine-tuned on technical documentation. The server sends the prompt sentence over an application programming interface and receives response information formatted as natural-language text.

The server parses the response information to extract time information, proposed setting values for cooling equipment, proposed load distribution among computing devices, and explanatory text describing reasons for these settings. The server may apply a deterministic parsing algorithm based on template sections (e.g., “Time Interval:, Cooling Set-Points:, Load Distribution:, Rationale:”) that are requested in the prompt sentence. The server converts the parsed values into internal data structures representing candidate operational conditions.

The server compares the candidate operational conditions obtained via the generative AI model with the numerically calculated operational conditions obtained via the predictive and optimization models. The server checks consistency against safety conditions and constraint conditions, including maximum allowable temperatures, minimum airflow requirements, device operating ranges, and capacity limits. When the generative AI recommendation suggests a setting that violates any safety or constraint rule, the server either adjusts that setting to the nearest safe value or marks it as invalid. The server then generates integrated operational conditions by merging non-conflicting numerical recommendations and generative recommendations and by resolving conflicts in accordance with a predefined priority policy or tie-breaking logic.

The server generates display information that includes the integrated operational conditions, the operational policy information in natural language from the generative AI model, and relevant explanatory information such as predicted energy savings, predicted temperature profiles, and reasons for particular constraints. The server encodes the display information into a format consumable by the terminal, such as a structured message containing chart data, tables, and explanatory text.

The terminal receives the display information from the server and renders user interface elements on a display device. The terminal presents graphs of historical and predicted temperatures and power consumption, heatmaps of rack temperatures, and lists of recommendations. The terminal displays both numerical set-points and corresponding explanatory text, so that the user can understand why a specific integrated operational condition is proposed.

The terminal also displays an input screen for the user to enter a prompt sentence in natural language. The user uses a keyboard, pointing device, or touch input to type a free-description question or instruction, for example:

“Please analyze the last 7 days of data center operation and suggest three alternative cooling configurations that maintain all rack inlet temperatures below 26 degrees Celsius and reduce energy consumption by at least 10 percent, explaining the trade-offs between each configuration.” The terminal transmits the user-entered prompt sentence to the server. The server incorporates this user-provided prompt into inquiry information, sends it to the generative AI model, receives response information, and forwards the response information to the terminal. The terminal then displays the response information in association with the original input screen, enabling the user to interactively refine operational strategies using natural language without directly manipulating low-level configuration parameters.

The user reviews the integrated operational conditions and the natural-language explanations. The user can accept recommended conditions, modify specific set-points, or reject certain suggestions. The user interacts with graphical controls on the terminal to indicate acceptance or modification, and the terminal transmits corresponding operation information to the server. The server interprets the operation information and determines which integrated operational conditions should be executed.

The server generates control information for the building facility management device and the cooling facility control device. The server maps integrated operational conditions, such as target supply air temperatures and fan speed schedules, to specific actuator commands understood by the control devices. For example, the server converts a target chiller leaving water temperature into a control register value for a chiller controller and transmits it over an industrial control protocol. The cooling facility control device receives the control information and adjusts physical actuators accordingly. The result is that air flow, coolant flow, and set-point temperatures in the physical facility are changed in accordance with the integrated operational conditions computed and reconciled by the server.

The server stores history information describing executed control actions, such as timestamps, parameter values, and associated integrated operational conditions, in the storage. The server later uses this history information to retrain models, evaluate performance, and refine safety and constraint rules. By incorporating executed actions and their outcomes into the training data, the server continuously improves prediction accuracy and the quality of operational recommendations. This configuration provides technical effects beyond mere automation of human decision-making. The server uses specialized data structures and algorithmic flows to integrate time-series sensor data, external weather and price data, machine-learned predictive models, and generative natural-language reasoning in a closed loop. The standardized time-series information and feature store representation enable efficient retrieval and computation, thereby reducing processing time and memory usage compared to ad hoc data processing. The anomaly detection using autoencoders allows the server to detect subtle patterns that would be difficult for humans to identify reliably, improving error detection and reducing the risk of undetected thermal issues.

The combined use of predictive models and generative AI model outputs, reconciled under explicit safety and constraint conditions, improves reliability and technical performance of the control system. The server does not simply execute a generic language model recommendation; instead, the server mathematically bounds the recommendations by internal predictive models and codified constraints, and performs deterministic conflict resolution. This architecture reduces erroneous or unsafe control actions and provides a stable and explainable basis for automatic actuator control. Because the server constructs prompt sentences programmatically from structured explanatory information, the server reduces communication overhead between internal modules and the generative AI model. The server transmits only condensed, technically relevant context, which also improves the quality and determinism of generative outputs. Furthermore, by accepting user intent via natural-language prompt sentences processed through the server, the system reduces configuration complexity and error rates associated with manual scripting, thereby improving the usability and safety of the computing environment without requiring the user to directly modify low-level configuration files.

Alternative embodiments are possible. The server may employ different model architectures, such as a transformer-based time-series model for forecasting, or a one-class support vector machine for anomaly detection. The server may adjust the feature set to include additional signals, such as equipment status flags or network load indicators. The generative AI model may be deployed on-premises or accessed as a remote service. The server may implement alternative conflict resolution policies between numerical and generative outputs, such as weighting rules based on model confidence or historical performance metrics. The terminal may be implemented as a mobile device interface or a web-based console. Despite these variations, the essential technical concept remains that the server integrates numerical predictive computation and generative natural-language reasoning with explicit constraint checking and direct control of physical cooling and facility equipment, thereby improving the functioning of the computer system and the efficiency and safety of data center cooling and energy management.

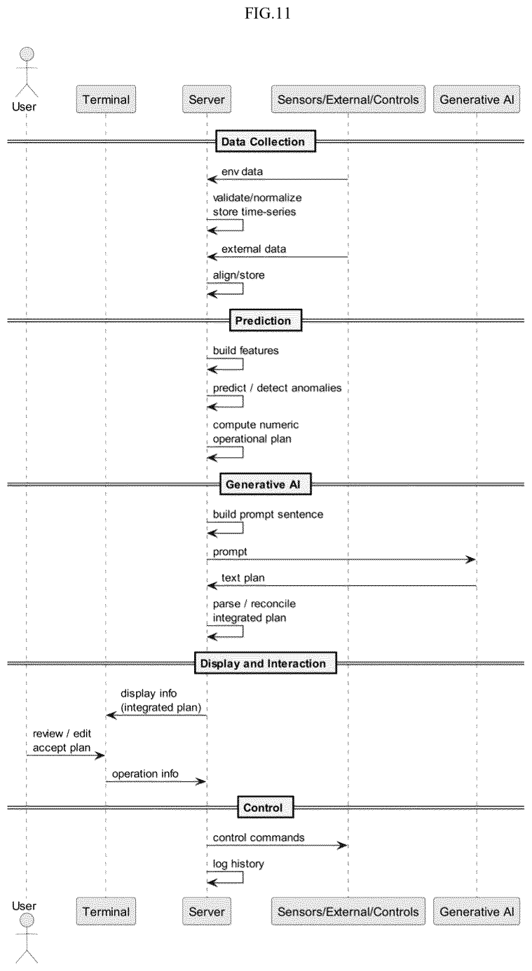

The following describes the processing flow using FIG. 11.

### Step 1:

Server receives raw environmental information from information acquisition devices. Server uses the communication network to accept incoming messages that include identification information, time information, and at least one measured value such as temperature, humidity, power, flow, or pressure. As input, Server takes raw sensor payloads (for example, multiple JSON-like or binary frames from various sensors). Server parses the payloads, separates fields, and verifies that each message originates from a registered sensor by checking the identification information against a configuration table stored in memory. As output, Server produces a stream of parsed records in an internal buffer, each record containing a sensor identifier, a timestamp, and a raw measured value ready for validation.

### Step 2:

Server validates and filters the parsed environmental information.

Server takes, as input, the parsed records from Step 1 and configuration data defining valid ranges and formats for each sensor type. Server checks the time information for correct format and chronological consistency, and compares each measured value with predefined physical bounds and recent statistical characteristics (for example, rolling mean and standard deviation for the last N minutes). Server classifies records with missing fields, out-of-range values, or extreme deviations as abnormal. Server discards or flags these abnormal records and retains normal records. As output, Server generates a cleaned record set in which each record is labeled as valid and ready for standardization.

### Step 3:

Server standardizes units and constructs time-series information.

Server uses, as input, the cleaned record set from Step 2 and a mapping from sensor identifiers to logical locations and metric types. Server converts measured values into standard units (for example, Fahrenheit to Celsius, Pascal to kilopascal), and rounds timestamps to a common time grid such as a 60-second interval. For time intervals where multiple measurements from the same metric and location exist, Server aggregates values using an averaging function or another aggregation method. Server then creates time-series records containing a time index, normalized value, location identifier, and metric type. As output, Server stores the generated time-series information in structured tables of a storage system, indexed by time and location.

### Step 4:

Server acquires and aligns external information.

Server periodically issues requests over the communication network to external information providing devices. As input, Server uses configuration parameters such as query intervals, geographic coordinates, and authentication tokens. Server receives weather information (for example, outside temperature, humidity, wind speed) and price information (for example, time-varying energy tariffs) as structured messages. Server converts external timestamps to a common time zone and snaps them to the same time grid used for internal time-series information. Server then aligns external records with internal time-series records based on the shared time index. As output, Server stores aligned external information in tables linked to corresponding time-series entries.

### Step 5:

Server generates feature vectors from internal and external information.

Server reads, as input, a selection of time-series information and aligned external information for a specified historical window (for example, the last 24 hours or 30 days). Server computes derived quantities, including rolling averages, rolling variances, temporal gradients, power-to-temperature ratios, and aggregated loads per rack group or zone. Server also encodes external information such as current and forecasted prices or outside temperatures as numerical features aligned by time. Server combines these derived internal and external values into feature vectors, each vector corresponding to a particular time point or time window. As output, Server writes the feature vectors into a feature store table with associated metadata such as labels indicating training, validation, or inference usage.

### Step 6:

Server trains predictive models for forecasting and anomaly detection.

Server takes, as input, training feature vectors and corresponding target values, such as future power consumption or future rack inlet temperatures, drawn from the feature store and time-series tables. Server constructs model architectures such as recurrent neural networks (for example, gated recurrent unit layers), temporal convolutional networks, or gradient boosting tree ensembles. Server defines loss functions such as mean squared error for forecasting and reconstruction error for autoencoder-based anomaly detection. Server iteratively performs forward passes to generate predictions, computes gradients of the loss functions, and updates model parameters using an optimization algorithm such as stochastic gradient descent with adaptive learning rate. As output,

Server stores trained model parameters, along with performance metrics and version identifiers, in the storage.

### Step 7:

Server performs continuous inference for future state prediction.

Server periodically retrieves, as input, the most recent feature vectors corresponding to current and recent environmental and external conditions. Server loads the trained forecasting models from storage and runs inference to obtain predicted future values of power consumption information and temperature information for upcoming time intervals. Server also applies anomaly detection models to the current feature vectors, calculating anomaly scores and marking any vectors exceeding predefined thresholds as anomalous. As output, Server generates prediction records containing future values and anomaly records containing anomaly flags and scores, and stores them in dedicated prediction and anomaly tables.

### Step 8:

Server computes numerical operational conditions.

Server uses, as input, the prediction records from Step 7, current time-series information, and external information such as forecasted prices. Server applies optimization rules, heuristics, or secondary models to translate predicted values and constraints into operation conditions of cooling equipment and load distribution conditions of an information processing device group. For example, Server calculates new target supply air temperatures, fan speed curves, and time windows for shifting non-critical workload from peak-price periods to off-peak periods. Server ensures that calculated conditions respect safety conditions such as maximum allowable rack inlet temperature and minimum airflow per rack. As output, Server produces a set of numerically derived operational conditions expressed as structured parameter sets per device and time interval.

### Step 9:

Server constructs explanatory information and prompt sentences.

Server takes as input the numerically derived operational conditions, current and predicted environmental states, and external information. Server synthesizes explanatory information summarizing key aspects such as predicted peaks, constraint limits, and expected savings. Server then converts this explanatory information into natural-language text segments describing the situation and objectives. Based on these segments, Server builds at least one prompt sentence to be sent to a generative AI model. For example, Server may construct a prompt sentence of the form: “Current average rack inlet temperature is 26.5 degrees Celsius and is predicted to reach 28.0 degrees Celsius between 18:00 and 20:00. Outside air temperature will drop below 10 degrees Celsius after 22:00. Electricity prices will be highest between 18:00 and 21:00. Please propose an optimized cooling and load scheduling plan for the next 12 hours that minimizes energy cost while keeping rack inlet temperatures below 27 degrees Celsius. Output a step-by-step timetable with set-points and justification.”

As output, Server produces inquiry information that embeds this prompt sentence and is ready for transmission to the generative AI model.

### Step 10:

Server queries the generative AI model and receives natural-language operational policy information.

Server sends, as input, the inquiry information containing the prompt sentence to the generative AI model over a defined application programming interface. Server specifies parameters for the generative AI model, such as maximum response length and sampling settings. Server then receives, as output from the generative AI model, natural-language response information that includes suggested operating schedules, set-points, load distribution strategies, and textual rationale. Server stores the raw response text and prepares it for parsing in subsequent processing.

### Step 11:

Server parses generative AI responses into candidate operational conditions.

Server uses, as input, the natural-language response information from Step 10 and any formatting constraints specified in the prompt sentence (for example, labeled headings or list formats). Server applies parsing procedures such as pattern matching and text segmentation to identify time intervals, equipment identifiers, proposed setting values, and corresponding explanations. Server converts textual descriptions of set-points and schedules into numerical or symbolic values aligned to internal representations used for control. As output, Server generates structured candidate operational conditions and associates them with explanatory text segments extracted from the response.

### Step 12:

Server reconciles numerical and generative operational conditions to form integrated operational conditions.

Server takes as input the numerically derived operational conditions from Step 8, the candidate operational conditions from Step 11, and encoded safety conditions and constraint conditions. Server compares corresponding settings device by device and time-interval by time-interval, checking for conflicts such as proposed temperatures exceeding maximum allowable limits or fan speeds below minimum airflow requirements. When conflicts are detected, Server either adjusts the candidate values to the nearest safe boundary or discards conflicting elements according to a predetermined priority rule. Server then merges non-conflicting numerical and generative elements into a unified set of integrated operational conditions, maintaining links to explanatory text where applicable. As output, Server produces an integrated operational condition set annotated with origin tags and compliance with safety and constraint rules.

### Step 13:

Server prepares display information for the terminal.

Server uses, as input, the integrated operational conditions from Step 12, prediction records, anomaly records, and explanatory text segments. Server formats time-series data for charts, constructs tables listing proposed set-points and schedules, and attaches natural-language explanations to each relevant operational parameter. Server encapsulates this information into a structured display payload suitable for rendering by the terminal's user interface components. As output, Server transmits the display information over the communication network to the terminal.

### Step 14:

Terminal renders visualizations and recommendation details for the user.

Terminal receives, as input, the display information from the server. Terminal interprets chart data to draw graphs of temperatures, power consumption, and forecast curves. Terminal renders heatmaps of rack temperatures and lists of integrated operational conditions, including equipment identifiers, time intervals, and new set-points. Terminal also displays associated natural-language explanations alongside numerical settings, so that the user can see both the technical parameters and the rationale. As output, Terminal presents an interactive user interface that allows the user to review system state and recommendations.

### Step 15:

User reviews integrated operational conditions and interacts with the terminal.

User observes, as input, the visualizations and explanations displayed by the terminal. User examines predicted peaks, proposed cooling set-points, and recommended load shifts, and may open detail panels to view explanations or expected savings. User decides which recommendations to accept, modify, or reject based on operational goals or policies. User manipulates interactive controls, such as checkboxes, sliders, and text fields, to indicate acceptance, adjust specific values, or disable certain conditions. As output, User causes the terminal to generate operation information that encodes these decisions.

### Step 16:

Terminal transmits operation information to the server.

Terminal collects, as input, the user's interactions with the interface, including accepted conditions, modified set-points, and rejected items. Terminal encodes this information into a structured message that references the integrated operational conditions and indicates the user's choices.

Terminal sends the operation information to the server over the communication network. As output, Terminal provides a machine-readable representation of the user's decisions for server-side processing.

### Step 17:

Server generates and sends control information to facility control devices and logs history. Server receives, as input, the operation information from Step 16 and the integrated operational conditions referenced within that information. Server identifies which operational conditions have been approved or modified by the user and converts those conditions into control commands formatted for the building facility management device and the cooling facility control device. Server maps each set-point, schedule, or load distribution parameter to specific control registers, signals, or API calls of the target devices. Server transmits the control information to the control devices, which then adjust actuators such as fans, pumps, and dampers in the physical facility. Server also records, as output, history information that includes the executed control commands, associated timestamps, and contextual data such as preceding predictions and conditions, storing this history information in the storage for later analysis, auditing, and model refinement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional energy management and cooling control systems for information processing facilities, such as data centers and similar infrastructure, are typically implemented as static rule-based or threshold-based controllers. In such systems, sensor data is collected and simple control rules are executed, but the systems do not fully exploit time-series analysis, external environment information, and machine learning to generate predictive, adaptive control. As a result, these systems often fail to minimize energy consumption and operation cost under dynamically changing environmental and market conditions, and are unable to provide transparent, human-understandable rationales for their control decisions.

Moreover, conventional predictive control systems that do employ machine learning usually operate as closed, opaque components that output numerical setpoints or schedules. The generated control actions are difficult for human operators to understand, verify, or modify, because the systems do not provide contextual, natural language explanations or alternative scenarios. This lack of explainability reduces operator trust, makes it difficult to debug or tune the systems, and often results in conservative or suboptimal operation that underutilizes data-driven optimization.

In addition, existing systems generally treat human operators as passive recipients of alerts and setpoints, rather than as active participants in an interactive optimization loop. When an operator wishes to change operation conditions, such as allowable temperature bands, load shifting constraints, or trade-offs between cost and comfort, conventional systems require manual reconfiguration of scattered parameters or even offline model redesign. These processes are time-consuming, error-prone, and do not support rapid what-if analysis or scenario exploration in a production environment.

From the perspective of computer technology, there is also a technical deficiency in how heterogeneous data sources and advanced models are orchestrated. Sensor streams, external weather and market feeds, predictive models, optimization engines, and user interfaces are typically integrated in an ad hoc manner, without a unified representation that supports both machine-oriented computation and human-oriented explanation. This leads to complicated software architectures, duplicated logic, and difficulties in maintaining consistency between the data used for prediction, the data used for optimization, and the information presented on the operator dashboard. Furthermore, conventional systems do not effectively leverage generative AI models to bridge the gap between complex internal computation and human understanding. While generative models can, in principle, explain predictions and optimization results in natural language, known systems do not define how to systematically construct prompt sentences from structured time-series data, prediction outputs, optimization results, and anomaly information, nor how to convert the resulting natural language responses back into structured control parameters that can be consumed by a control and optimization loop. Consequently, the generative AI capability remains disconnected from the core control pipeline, and cannot be reliably used to improve the efficiency, transparency, and adaptability of the system.

Accordingly, there is a need for an improved computer-implemented system that: (i) collects and preprocesses observation information from sensors and external sources into unified time-series and feature sets; (ii) constructs and continuously updates predictive models for energy demand, cooling load, and related operation indices; (iii) computes optimized operation plans under explicit constraints; (iv) automatically generates structured prompt sentences for a generative AI model, based on the current predictive and optimization context; (v) converts natural language outputs of the generative AI model into structured action candidates; and (vi) supports an interactive feedback loop in which operator inputs dynamically modify operation conditions and trigger recalculation of both textual recommendations and operation plans. Such a system would improve the functioning of the computer itself by providing a more integrated architecture for data processing, model inference, generative explanation, and control command generation, thereby enabling more efficient, explainable, and adaptable facility operation.

The specific processing by the specific processing unit 290 of the data processing device 12 in Application Example 1 is realized by the following means.

The present invention provides a server comprising a processor configured to acquire observation information regarding an environmental state and an energy usage state in an information processing facility from an observation device as time-series information; to transmit the observation information via a communication network to an information storage area and to store the observation information as time-series information after performing preprocessing including duplicate elimination and unit normalization; to integrate the time-series information with external information including weather information and energy price information acquired from an external information providing device and to generate a feature set; to construct, based on the feature set, a prediction model that estimates, for future time points, at least one of energy demand, cooling load, and an operation index in the information processing facility by performing learning processing using a machine learning technique, and to dynamically update the prediction model in accordance with new time-series information and new external information; to calculate, based on an estimation result of the prediction model and on controllable equipment operation conditions and operation constraint conditions in the information processing facility, an operation plan for minimizing at least one of energy consumption and operation cost by executing optimization processing; to generate situation information including the estimation result of the prediction model, the operation plan calculated by the optimization processing, and past operation history, to summarize the situation information, to generate a prompt sentence including the summary and an instruction sentence regarding an operation policy, to input the prompt sentence to a generative information processing model, and to obtain from the generative information processing model natural language explanation information describing contents and grounds of the operation plan or an alternative operation plan; to analyze the natural language explanation information to extract structured information including at least one of candidate actions, execution time periods, target values, and expected effect amounts; to convert at least one of the natural language explanation information, the structured information, and the operation plan into display information presentable on a display device; to present the display information to an operation manager via a management display screen; to receive, from the management display screen, approval information or adjustment instruction information including changes in operation conditions such as allowable temperature ranges, load shift allowances, cost priorities, and comfort priorities; to update the operation plan based on the approval information or the adjustment instruction information and to generate control command information for an equipment control device in accordance with the updated operation plan; and to change operation conditions of equipment including at least one of a cooling device, a power load device, and a traffic control device based on the control command information and to collect a post-change operation state of the equipment again as the observation information, thereby continuously updating input information to the prediction model and to the generative information processing model through feedback control. This enables an improved computer-implemented control architecture in which heterogeneous sensor data, external information, predictive models, optimization processing, generative AI-based explanation, and operator inputs are integrated into a unified feedback loop, thereby improving the efficiency, transparency, and adaptability of energy and cooling management in information processing facilities while enhancing the functioning of the underlying computing system.

The term “information processing facility” refers to a facility in which multiple information processing devices, storage devices, and communication devices are installed and operated, and which consumes electric power and requires environmental control such as cooling, including, for example, a data center, a server room, or an equipment room.

The term “observation device” refers to a device or a combination of devices configured to acquire physical quantities or operation states in the information processing facility, such as temperature, humidity, air flow, power consumption, or equipment status, and to output the acquired values as observation information.

The term “observation information” refers to data representing measurement values or operation states obtained from an observation device, including at least a value, a time at which the value was acquired, and identification information of a measurement point or equipment.

The term “time-series information” refers to observation information or external information that is associated with time and stored or processed in chronological order, including sequences of records each having at least a timestamp and one or more associated values.

The term “communication network” refers to a wired or wireless communication infrastructure that enables data transfer between devices, including at least a local area network, a wide area network, or the Internet.

The term “information storage area” refers to a logical or physical storage resource, such as a database, a file system, or a storage service, that is configured to store time-series information, feature sets, models, operation plans, and other data used in the system.

The term “preprocessing” refers to processing performed on raw observation information prior to storage or analysis, including at least duplicate elimination, unit normalization, format conversion, error checking, or data cleaning.

The term “duplicate elimination” refers to processing in which multiple records representing the same measurement event, for example having the same identifier and timestamp, are detected and reduced so that only a single representative record is retained.

The term “unit normalization” refers to processing in which measurement values expressed in different physical units or formats are converted into a standardized unit system to enable consistent storage and analysis.

The term “external information” refers to information obtained from one or more external information providing devices outside the information processing facility, including at least weather information, energy price information, or grid status information.

The term “external information providing device” refers to an information source, such as a server or service, that provides external information via an interface such as an API or data feed.

The term “weather information” refers to information indicating meteorological conditions such as temperature, humidity, wind speed, precipitation, or weather forecasts at or around the location of the information processing facility.

The term “energy price information” refers to information indicating a price or tariff associated with electric power supply, including at least real-time prices, day-ahead prices, or contracted tariff schedules.

The term “feature set” refers to a collection of derived data elements, each representing a numerical or categorical feature computed from time-series information and external information, and used as input to a prediction model.

The term “prediction model” refers to a computational model constructed using a machine learning technique and configured to receive a feature set as input and to output estimated values of one or more target variables such as energy demand, cooling load, or an operation index for future time points.

The term “machine learning technique” refers to a computational technique in which a model is trained using sample data so that the model automatically learns relationships between input data and output targets, including, for example, neural networks, decision trees, or regression models. The term “prediction processing device” refers to a computing resource, which may be implemented by the same processor or a different processor, that executes learning processing and inference processing for constructing and using the prediction model.

The term “energy demand” refers to an amount of electric power or energy required by the information processing facility or part thereof during a given time period.

The term “cooling load” refers to an amount of cooling capacity required to maintain environmental conditions, such as temperature or humidity, in the information processing facility within specified ranges.

The term “operation index” refers to a performance-related index representing an operation state of the information processing facility, including at least indicators of efficiency, utilization, or comfort level.

The term “controllable equipment operation conditions” refers to parameters defining an operation state of equipment that can be directly or indirectly adjusted by the system, such as setpoints, schedules, capacities, or priorities.

The term “operation constraint conditions” refers to conditions or limits that restrict permissible operation states or changes of equipment, such as safety limits, comfort ranges, contractual limits, or regulatory requirements.

The term “operation plan” refers to a set of planned control actions or schedules specifying, for one or more future time periods, how controllable equipment operation conditions are to be set in order to achieve an objective such as minimizing energy consumption or operation cost.

The term “optimization processing” refers to computational processing that formulates an objective function and constraints based on prediction results and operation conditions, and that determines values of decision variables so as to minimize or maximize the objective function while satisfying the constraints.

The term “situation information” refers to information that represents a current or planned operation context of the information processing facility, including at least prediction results, operation plans, past operation history, and optionally abnormal event information.

The term “past operation history” refers to stored records of previous operation conditions, control actions, and resulting observation information for the information processing facility.

The term “prompt sentence” refers to a structured natural language text generated by the system and provided to a generative information processing model, the text including a summary of situation information and instructions defining a task to be performed by the generative information processing model.

The term “instruction sentence regarding an operation policy” refers to a part of a prompt sentence that explicitly describes what kind of explanation, recommendation, or alternative plan is requested from the generative information processing model.

The term “generative information processing model” refers to a trained computational model, such as a generative AI model, that receives a prompt sentence and outputs natural language text or equivalent content generated on the basis of the prompt sentence.

The term “natural language explanation information” refers to text generated by the generative information processing model in a human language, describing at least contents and grounds of an operation plan, an alternative operation plan, or an analysis of an operation scenario. The term “alternative operation plan” refers to a plan for controlling equipment that differs from a primary operation plan and that is generated by or via the generative information processing model as a candidate scenario.

The term “structured information” refers to information obtained by analyzing the natural language explanation information and organizing it into a machine-readable structure, including at least candidate actions, execution time periods, target values, or expected effect amounts.

The term “candidate action” refers to a proposed control operation or change in operation condition, such as adjusting a setpoint, shifting a load, or changing a schedule.

The term “execution time period” refers to a time interval during which a candidate action or control operation is intended to be executed.

The term “target value” refers to a numerical or categorical value that is to be achieved by performing a candidate action, such as a temperature setpoint, a load level, or a target reduction amount.

The term “expected effect amount” refers to a quantitative or qualitative indication of an anticipated result of executing a candidate action, such as a predicted reduction in energy consumption, cost, or peak demand.

The term “display information” refers to data formatted for presentation on a display device, including at least text, numerical values, and graphical elements representing prediction results, operation plans, and explanation information.

The term “display device” refers to a device capable of visually presenting display information to a user, such as a monitor, a terminal screen, or a mobile display.

The term “management display screen” refers to a graphical user interface presented on a display device and configured to allow an operation manager to view situation information, prediction results, operation plans, and explanation information, and to input approval information or adjustment instruction information.

The term “operation manager” refers to a human user responsible for monitoring and controlling the operation of the information processing facility, and for providing approval or adjustment instructions to the system.

The term “approval information” refers to input information indicating that the operation manager has approved all or part of an operation plan, candidate actions, or recommendations.

The term “adjustment instruction information” refers to input information indicating modifications requested by the operation manager, including changes to operation conditions, candidate actions, or priorities.

The term “operation conditions” refers to parameters defining desired or acceptable operation states of equipment or of the information processing facility, such as allowable temperature ranges, load shift allowances, cost priorities, or comfort priorities.

The term “allowable temperature range” refers to a range of temperatures within which an environmental condition of the information processing facility is considered acceptable for operation.

The term “load shift allowance” refers to a permissible degree or limit for temporally shifting electric loads relative to a baseline schedule.

The term “cost priority” refers to a relative importance assigned to minimizing operation cost when determining or adjusting an operation plan.

The term “comfort priority” refers to a relative importance assigned to maintaining comfort-related conditions, such as temperature or humidity, when determining or adjusting an operation plan. The term “control command information” refers to information specifying control instructions to be sent to an equipment control device, including at least target setpoints, schedules, or switching commands.

The term “equipment control device” refers to a device or subsystem that receives control command information and directly or indirectly controls operation conditions of equipment such as cooling devices, power load devices, or traffic control devices.

The term “cooling device” refers to equipment configured to remove heat from the information processing facility or part thereof, such as an air conditioning unit, a chiller, or a fan system. The term “power load device” refers to equipment that consumes electric power in the information processing facility, such as computing equipment, lighting, or auxiliary mechanical equipment. The term “traffic control device” refers to equipment that controls flow of physical traffic related to the facility or its surroundings, such as a signal controller, a gate controller, or a similar control apparatus.

The term “feedback control” refers to processing in which the system changes operation conditions of equipment based on control command information, then collects observation information representing a post-change operation state, and uses the collected observation information to update models or subsequent control actions.

In one embodiment, a server cooperates with a terminal and a user to implement an energy and cooling management system for an information processing facility. The server includes at least one processor, a memory, a non-transitory storage device, and a network interface. The terminal includes a display device, an input device such as a keyboard, a pointing device or a touch panel, and a communication interface. The user operates the terminal to interact with the server. The server uses general-purpose computing hardware, such as a multi-core central processing unit, optionally combined with one or more graphics processing units for machine learning computation. The server stores software components including an operating system, a database management system, a stream-processing framework, a machine learning framework, and an application server. For example, the server uses a relational or time-series database (such as a relational database engine), a distributed processing framework (such as a batch or stream processing engine), and machine learning libraries (such as a neural network library, a gradient-boosted tree library, and a statistical anomaly detection library). The server also uses a web application framework to provide a management display screen to the terminal.

The server acquires observation information from multiple observation devices installed in the information processing facility. The observation devices include, for example, temperature sensors, humidity sensors, flow sensors, power meters for racks or distribution panels, and status monitors of cooling equipment or power distribution equipment. The server receives measurement values, device identifiers, and local timestamps over a communication network using protocols such as a message queuing protocol or a representational state transfer protocol. The server converts device-specific payloads into a unified data structure consisting of at least a global timestamp, a measurement value, a measurement type, and a location identifier, and stores the unified records as time-series information.

The server performs preprocessing on the time-series information in the memory and storage device. The server carries out duplicate elimination by comparing a sensor identifier and a timestamp, discarding or merging records that fall within a predefined tolerance window. The server executes unit normalization by converting measurement values to standardized units, for example converting power values to watts or kilowatts and temperature values to degrees Celsius, and normalizes ranges for numerical stability in subsequent machine learning processing. The server performs error checks by discarding or flagging records outside physically possible ranges, and may impute missing values using statistical interpolation methods implemented in the distributed processing framework. By performing these specific preprocessing steps on well-defined data structures, the server reduces data inconsistency and improves the numerical conditioning of later learning and optimization, thereby increasing computational efficiency and prediction accuracy.

The server acquires external information from one or more external information providing devices. The server periodically retrieves weather information, including temperature, humidity, wind speed, and forecast values, and energy price information, including real-time prices, day-ahead prices, and tariff schedule parameters, from external servers via a secure communication protocol. The server maps external information to the same time axis as the internal time-series information using interpolation or alignment procedures based on timestamps, and associates each external record with one or more zones or subsystems of the facility. The server generates a feature set by combining internal time-series information and external information; for each time step and each zone, the server computes features such as current and lagged measurements (for example, power consumption at t, t-1, t-24), rolling statistics (for example, moving average and moving standard deviation over the past N samples), categorical encodings (for example, hour-of-day, day-of-week, holiday flag), and interaction terms between internal and external variables (for example, product of outside temperature and server utilization). These explicit feature definitions allow the prediction model to capture temporal and environmental dependencies that could not be practically exploited by manual rules.

The server constructs a prediction model using the feature set. In one embodiment, the server implements a recurrent neural network, such as a long short-term memory network, as the prediction model. The server defines an input layer receiving a sequence of feature vectors of fixed length, one or more recurrent layers with a defined number of hidden units, and a fully connected output layer producing predicted values of energy demand, cooling load, or another operation index for one or more future time points. The server initializes model parameters randomly or with a heuristic, selects a loss function such as a mean squared error or a mean absolute error between predicted and actual values, and uses an optimization algorithm such as a gradient-based optimizer to update weights. The server performs mini-batch training over historical data stored in the database by iteratively computing gradients of the loss function with respect to the model parameters and adjusting the parameters to minimize the loss. The server optionally applies regularization techniques, such as dropout or weight decay, to prevent overfitting, and performs validation on a separate dataset to select suitable hyperparameters such as learning rate, batch size, and number of layers. By using this neural network-based prediction model with explicitly defined architecture, loss function, and training procedure, the server provides a data-driven prediction mechanism that surpasses human-crafted rules, both in predictive accuracy and in adaptability to changing operating conditions.

In another embodiment, the server uses non-recurrent architectures such as temporal convolutional networks, gradient-boosted decision trees, or ensemble methods implemented in the machine learning library to construct the prediction model. The server may select the model type automatically based on validation performance metrics such as root mean squared error or mean absolute percentage error, and store the selected model in a model registry along with version information and training metadata. The server periodically retrains or fine-tunes the prediction model as new time-series information and external information accumulate, thereby dynamically updating the model in response to long-term shifts in facility behavior or environmental conditions. The server constructs operation plans using optimization processing based on the estimation results provided by the prediction model. The server formulates an optimization problem in which decision variables represent controllable equipment operation conditions, such as temperature setpoints for cooling equipment, target load levels for shiftable equipment, or schedule offsets for batch operations. The server defines an objective function that combines predicted energy cost and other penalties, for example a weighted sum of predicted energy cost, peak demand charges, and discomfort indicators. The server enforces operation constraint conditions such as allowable temperature ranges for equipment or rooms, power capacity limits of circuits, maximum allowable rates of change for setpoints, and maintenance windows. The server uses a mathematical programming solver, such as a linear or mixed-integer programming solver, to compute an operation plan over a planning horizon. This processing is not limited to simple heuristics; instead, the server solves a mathematically defined optimization problem that systematically explores a large space of possible schedules, which cannot be feasibly evaluated manually by a human operator. Because the input to the optimization is the prediction model output together with explicitly defined constraints, the optimization processing yields plans that are both energy-efficient and operationally feasible.

The server constructs situation information by combining prediction results, optimization results, and past operation history. The server stores, for each planning cycle, time-indexed prediction values, selected decision variable values, cost estimates, and summary statistics such as predicted peak demand and expected savings relative to a baseline. The server also retrieves past operation history, including records of executed control commands and resulting sensor measurements, to provide context for current recommendations. The server summarizes this situation information by computing aggregates and extracting key events, for example, “predicted peak load in a certain time window exceeds a threshold,” or “planned reduction in setpoint yields an expected reduction in peak demand.”

The server generates a prompt sentence for a generative AI model based on the summarized situation information. The server assembles the prompt as a text sequence composed of structured sections, such as “Context,” “Data,” and “Task,” where the “Context” section describes the type of facility and overall goal, the “Data” section lists key numerical and categorical facts extracted from prediction results and operation plans, and the “Task” section instructs the generative model to perform a specific action such as explaining a plan, proposing an alternative plan, or analyzing anomalies. For example, the server may generate a prompt sentence such as:

“Context: This is an information processing facility energy and cooling management system. The system collects real-time data on electricity consumption, equipment status, and environmental conditions in multiple zones.

Data: In Zone A, the predicted peak electricity demand between 14:00 and 17:00 is 25 percent higher than the usual weekday pattern. The outside temperature is forecast to reach 35 degrees Celsius, and real-time electricity prices are expected to increase by 40 percent during the same period. Controllable loads include cooling equipment, non-critical computing tasks, and auxiliary mechanical equipment.

Task: Based on this information, propose an operational plan that minimizes energy cost and peak demand while maintaining indoor temperatures between 22 degrees Celsius and 26 degrees Celsius in all occupied areas. Describe specific control actions for cooling equipment, scheduling of non-critical loads, and any recommended adjustments to load distribution. Present the plan in bullet points and include estimated percentage reductions in peak demand and cost.”

The server transmits such a prompt sentence to a generative AI model, such as a large language model executed on the same server hardware or on a remote computation service. The server receives natural language explanation information from the generative AI model. The generative AI model is not merely used as a black box; instead, the server defines a specific interface and expectations: the model receives structurally organized prompt text and returns responses that contain descriptions of actions, time intervals, and estimated effects. The server applies text analysis procedures to the returned response. The server identifies candidate actions by searching for imperative statements or bullet list items, extracts execution time periods using pattern recognition of time expressions, extracts target values by recognizing numerical expressions associated with units (for example, degrees Celsius or kilowatts), and extracts expected effect amounts by detecting phrases expressing predicted percentage reductions or energy savings. The server converts the extracted items into structured information with explicit fields and stores the structured information in the database.

The server then uses the structured information in conjunction with the optimization processing. In one variation, the server checks whether the generative model's proposed candidate actions violate any known constraints; if they do, the server discards or modifies the actions before incorporating them into a new optimization formulation. In another variation, the server uses the generative model's structured recommendations as initial values or soft preferences for the optimization solver, thereby guiding the solver toward human-comprehensible plans while preserving constraint compliance. By converting back and forth between structured data and natural language explanations in a defined manner, the server integrates the generative AI model into the core technical loop of prediction and optimization, rather than using it only as an external advisory tool. This integration changes how the computer processes and manages control information, improving the clarity and traceability of internal decision making.

The terminal communicates with the server to obtain display information generated by the server. The terminal renders a management display screen that includes visualizations of time-series plots, predicted consumption profiles, optimized schedules, and natural language explanations. The terminal uses a graphical rendering library to plot data and to highlight periods of high predicted load and intervals where control actions are planned. The terminal displays the natural language explanation information and the alternative operation plan as text panels. The user views the display screen and can approve, reject, or modify candidate actions. The user can adjust operation conditions such as allowable temperature ranges, maximum permitted load shifting percentage, and relative weighting of cost versus comfort by interacting with input components on the terminal. The terminal sends approval information and adjustment instruction information to the server as structured messages. The server updates stored operation conditions accordingly and re-runs prediction and optimization processing if necessary. The server may also generate a new prompt sentence that explicitly mentions the updated conditions, for example:

“Task: Recalculate the recommendations assuming indoor temperature must remain between 23 degrees Celsius and 25 degrees Celsius and total load shifting must not exceed 15 percent of baseline demand. Explain how the new constraints change the expected cost savings and peak reduction.”

The server thus builds an interactive control loop in which the user influences constraints and objectives, the predictive and optimization components compute revised plans, and the generative AI component produces updated explanations. This loop is not a mere automation of a human workflow; because the server maintains consistent data structures, model states, and optimization problems, the system can explore combinations of actions and constraints that would be impractical for a human operator to enumerate, and it can update its internal models dynamically based on feedback from executed actions and measured outcomes.

The server generates control command information based on the updated operation plan. The server maps decision variable values to specific device control parameters, such as setpoint temperature changes for cooling equipment, schedule shifts for non-critical loads, or activation signals for standby systems. The server transmits control commands to equipment control devices using industrial communication protocols appropriate to the equipment type. As a result, cooling devices, power load devices, or other controllable equipment change their operating conditions according to the computed plan. The server measures the resulting operation states via the observation devices, and feeds the new observation information back into the time-series storage and into subsequent training and evaluation of the prediction model. This closed-loop operation ensures that the models are continuously aligned with actual facility behavior.

The technical effects of this configuration include improved prediction accuracy due to the explicit feature engineering and structured neural network architecture, improved optimization efficiency due to the formulation of mathematically defined problems with well-defined constraints, and improved data management through normalized time-series structures and centralized model and plan storage. The server reduces communication load and processing latency by aggregating required data for the management display screen into compact data structures before transmission to the terminal. The server reduces operator cognitive load and error risk by automatically generating human-readable explanations and alternative plans tailored to the current facility state, while still grounding such explanations in machine-evaluable structures. From a computer technology perspective, the specific combination of predictive modeling, optimization, generative AI integration via prompt sentences, and structured extraction of actions produces a new dataflow and control architecture inside the server that changes how the computing system processes, organizes, and utilizes control data, resulting in faster convergence of control plans, reduced misalignment between model outputs and human decisions, and lower overall energy consumption for the facility.

In alternative embodiments, the server uses different machine learning models, such as convolutional neural networks for time-series, probabilistic graphical models, or hybrid models combining neural networks with rule-based components. The server may employ different optimization techniques, such as heuristic search, reinforcement learning-based controllers, or distributed optimization across multiple servers, while still using the described prompt generation and structured analysis mechanism to integrate generative AI explanations. The server may also adapt the described methods to other technical domains, such as management of thermal conditions in manufacturing plants or integrated control of traffic signals and roadside equipment, provided that observation devices, predictive models, optimization processing, and generative AI-based explanation are combined in a similar feedback architecture.

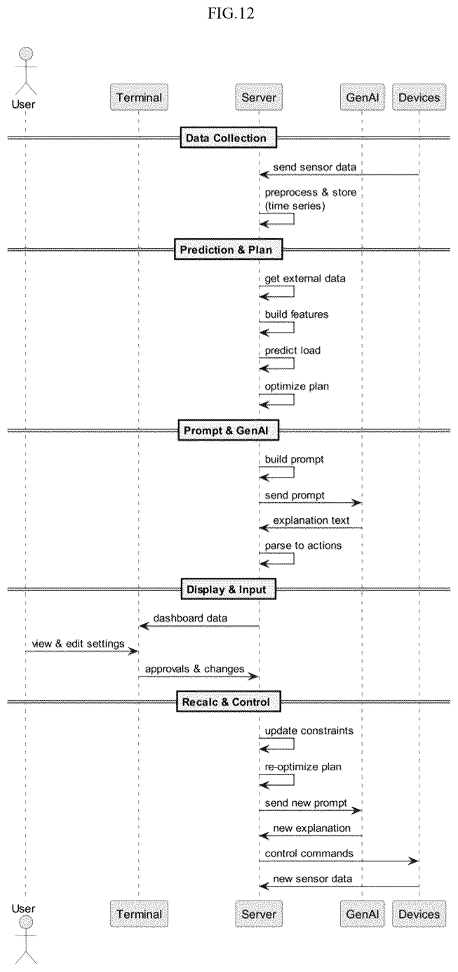

The following describes the processing flow using FIG. 12.

### Step 1:

The server receives raw observation information from observation devices.

The input to Step 1 is device-specific messages including sensor identifier, local timestamp, and raw measurement value. The server parses each message, validates a device identifier and an authentication token, converts the local timestamp into a unified time standard, and attaches location information from a registration table. The server outputs normalized observation records, each containing at least a global timestamp, a measurement type, a location identifier, and a numeric value, in a temporary buffer.

### Step 2:

The server performs preprocessing on the normalized observation records.

The input to Step 2 is the buffer of normalized observation records from Step 1. The server executes duplicate elimination by sorting records by device identifier and timestamp and discarding records that fall within a predefined time tolerance and have identical values. The server executes unit normalization by checking a measurement type and converting each value into a standardized unit using a conversion table. The server performs range checking and flags or removes values outside predefined physical limits. The server stores the cleaned and normalized time-series information in a time-series table in a database and outputs references (such as record identifiers and time ranges) for subsequent processing.

### Step 3:

The server acquires external information and aligns it with internal time-series information. The input to Step 3 is a time range and location identifiers derived from the stored time-series information. The server sends requests to external information providing devices to obtain weather information and energy price information for the relevant time range and locations. The server parses responses, extracts numerical values and timestamps, and interpolates missing time points using linear interpolation or step-wise hold. The server aligns external records with internal time-series records by matching or interpolating timestamps and mapping external locations to facility zones. The server outputs combined external-internal records, each including internal measurements and corresponding external variables.

### Step 4:

The server generates feature sets for prediction processing.

The input to Step 4 is the combined external-internal records from Step 3. The server groups records by facility zone and by time index, and constructs feature vectors by computing lag features (for example, values at previous time steps), rolling statistics (for example, moving averages over a defined window), and categorical encodings (for example, hour-of-day and day-of-week). The server concatenates these values into ordered numerical arrays representing feature vectors. The server stores the feature vectors in a feature table and outputs batches of feature vectors and associated target values for use by a prediction model.

### Step 5:

The server trains or updates a prediction model using the feature sets.

The input to Step 5 is historical feature vectors and corresponding target values (such as historical energy demand or cooling load). The server initializes a neural network architecture with a defined number of input nodes, hidden layers, and output nodes. The server computes forward passes by multiplying input feature vectors by weight matrices, applying activation functions, and generating predicted outputs. The server computes an error value for each batch using a loss function comparing predicted and actual targets. The server backpropagates the error through the network to compute gradients and updates the weights using an optimization algorithm. The server repeats this process over multiple epochs until a convergence criterion is satisfied. The server stores the resulting trained model parameters and outputs a trained prediction model identifier for inference.

### Step 6:

The server performs prediction using the trained prediction model.

The input to Step 6 is the latest feature vectors generated in near real time and the trained prediction model identifier from Step 5. The server loads the corresponding model parameters into memory and applies the model to each input feature vector. The server computes predicted values of future energy demand, cooling load, or other operation indices for specified future time points. The server stores prediction results, including predicted values, prediction horizons, and confidence metrics, in a prediction result table, and outputs a summarized prediction profile for each facility zone.

### Step 7:

The server computes an optimized operation plan based on prediction results and constraints. The input to Step 7 is the summarized prediction profile from Step 6 and a set of controllable equipment operation conditions and operation constraint conditions stored in configuration tables. The server formulates an optimization problem by defining decision variables for setpoints and schedules, an objective function representing energy cost or peak demand, and constraint equations representing allowable temperature ranges, power limits, and rate-of-change limits. The server passes this formulation to an optimization solver, which iteratively searches for decision variable values that minimize the objective function while satisfying all constraints. The server receives the solution, validates feasibility, and converts the decision variable values into an operation plan specifying for each time period the target setpoints and schedules. The server stores the operation plan and outputs a plan summary including key actions and expected energy savings.

### Step 8:

The server constructs situation information and generates a prompt sentence for a generative AI model.

The input to Step 8 is the prediction result summary from Step 6, the operation plan summary from Step 7, and selected past operation history records from the database. The server compiles situation information by aggregating predicted peaks, planned control actions, historical baselines, and anomaly indicators into a structured representation. The server then converts this structured representation into natural language segments for a “Context” section and a “Data” section. The server appends a “Task” section describing what explanation or alternative plan is requested. The server concatenates these segments into a single prompt sentence. The server outputs the prompt sentence as a text string to be sent to a generative AI model.

### Step 9:

The server sends the prompt sentence to the generative AI model and receives natural language explanation information.

The input to Step 9 is the prompt sentence from Step 8. The server sends the prompt sentence to a generative AI model through an application programming interface, providing the text as input. The generative AI model returns a natural language response containing explanations, recommended actions, and estimated effects. The server receives this response as a text block and stores it in an explanation table. The server outputs the raw natural language explanation information for further analysis.

### Step 10:

The server analyzes the natural language explanation information and generates structured information.

The input to Step 10 is the raw natural language explanation information from Step 9. The server applies text processing and pattern recognition methods to identify sentences describing specific actions, time periods, target values, and expected effect amounts. The server uses keyword detection, regular expressions, and numerical parsing to extract structured elements such as action type, start time, end time, setpoint value, and predicted percentage reduction in peak demand. The server aggregates these extracted elements into structured records representing candidate actions. The server stores the structured information in a structured action table and outputs references to these candidate actions for integration with the operation plan.

### Step 11:

The server prepares display information for the terminal.

The input to Step 11 is prediction results from Step 6, operation plans from Step 7, and both natural language explanation information and structured information from Step 10. The server composes display data objects that include time-series arrays for charts, tabular data for operation schedules, and formatted text segments for explanations. The server reduces data volume by selecting key time points and aggregating less important intervals, and encodes the display data into a compact format suitable for network transmission. The server outputs the display information to the terminal via a communication interface.

### Step 12:

The terminal renders a management display screen and sends user inputs to the server. The input to Step 12 is the display information received from the server. The terminal renders time-series charts, tables, and explanation text on a display device, using graphical rendering functions to draw lines, bars, and textual labels. The terminal presents interactive controls allowing the user to approve or reject individual candidate actions and to adjust operation conditions such as allowable temperature ranges or maximum load shifting. When the user interacts with these controls, the terminal collects the user's choices and modified values, packages them into an approval information message or adjustment instruction message, and sends these messages back to the server. The terminal outputs user input data items indicating approvals, rejections, and updated constraints.

### Step 13:

The user reviews the displayed information and issues operation condition changes.

The input to Step 13 is the management display screen shown by the terminal. The user observes predicted demand curves, recommended operation plans, and natural language explanations, and evaluates whether the proposed actions satisfy operational policies and comfort requirements. The user operates input devices to change specific parameters, such as narrowing an allowable temperature range or limiting the percentage of load shifting, and to confirm which proposed actions to accept. The user thereby produces explicit operation condition changes and approval decisions, which the terminal transmits to the server as described in Step 12. The output of Step 13 is human-originated decisions encoded as structured input data.

### Step 14:

The server updates operation conditions and recalculates operation plans and explanations. The input to Step 14 is the approval information and adjustment instruction information from the terminal. The server writes updated operation conditions into configuration tables, marking previous conditions as historical versions. The server reevaluates whether the existing operation plan remains valid under the updated constraints; if not, the server re-invokes the optimization solver using the new limits and objectives to compute a revised operation plan. The server also generates a new prompt sentence describing the updated conditions and requests a revised explanation or recommendation from the generative AI model. The server receives the new explanation, repeats the analysis and structuring process, and updates stored operation plans and explanation records. The server outputs a refreshed plan summary and explanation set for subsequent display and control command generation.

### Step 15:

The server generates control command information and executes feedback control.

The input to Step 15 is the finalized operation plan and structured action information after user approval from Step 14. The server maps each approved action and plan element to specific equipment control parameters by referencing a device registry that associates facility zones and setpoints with individual equipment control devices. The server generates control command messages containing target values and activation times, and sends these messages over industrial communication protocols to the appropriate control devices. As equipment adjusts its operation, the server receives new observation information from observation devices, which becomes new input for Step 1. The server thereby closes the feedback loop, continuously refining prediction, optimization, and explanation based on measured outcomes.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional data center operation support systems focus on optimizing cooling control and energy efficiency by using environment data and external environment data as inputs to prediction models or rule-based engines. Such systems typically predict power consumption and cooling load, and then present recommended setpoints or schedules to an operator through a static dashboard. However, these conventional systems are not designed to adapt their internal information processing or their user interaction to the operator's cognitive condition or emotional state. As computing environments become more complex, this technical limitation creates several concrete problems in computer-implemented operation support.

First, existing systems generally use fixed data aggregation pipelines and fixed formats of recommendations, regardless of how much information the operator can realistically process at a given time. Prediction results and optimization outputs are often provided as complex charts, dense tables, and long textual explanations generated by generic reporting modules. When system anomalies occur and alarms are raised, an operator may be in a high-stress state and may interact with a management console in a hurried or confused manner. In such situations, the conventional approach of always presenting detailed analysis increases the cognitive load on the operator and makes it harder for the operator to correctly interpret recommended actions. This can lead to delayed responses, misconfiguration of cooling equipment, or suboptimal energy control, which in turn degrade the operational stability and efficiency of the data center as a computing environment. Second, although prediction modules and optimization modules running on servers use advanced machine learning models, they generally treat user interaction as an external factor and do not feed back user behavior or user-generated text into the core computation. The server typically collects logs for auditing or offline analysis only. As a consequence, the server does not dynamically modify the structure or constraints of its own generated recommendations at run time. The internal processing pipeline from sensor data to recommendation text remains static, which limits the ability of the computer system to allocate processing resources and output bandwidth in a way that matches human processing capabilities in different operational contexts.

Third, recent advances in generative AI models, such as large-scale language models, provide powerful capabilities to synthesize operation proposals in natural language. However, in conventional systems, these models are usually invoked with static or manually crafted prompts that are not systematically linked to the current state of the data center and the operator's state. Without structured integration of environment forecasts, external environment data, and real-time emotion estimation into the prompt itself, the generative AI model outputs may be verbose, inconsistent in structure, or misaligned with the urgency of the situation. This results in inefficiencies at the computer-system level, such as unnecessary consumption of compute and network resources for generating oversized texts, and suboptimal utilization of the generative AI model's capacity for structured decision support.

Fourth, existing dashboards and management consoles are typically configured with fixed layouts and display policies. Even when some adaptive UI techniques are used, they rarely derive their behavior from formally estimated emotional states based on both behavioral logs and linguistic features. As a result, the human-computer interface does not systematically adapt to reduce cognitive overload during critical events or to expose richer comparative information during normal operation. The lack of tight, model-driven coupling between server-side analytics, prompt generation, and UI presentation logic limits the overall throughput and reliability of the computer system as a tool for data center control.

Therefore, there is a need for a computer-implemented system that integrates environment data processing, external environment data processing, prediction modeling, emotion state estimation based on operation logs and natural language input, and dynamic prompt generation for a generative AI model, and that further controls the presentation format of the generated operation proposals based on the estimated emotional state. By reconfiguring how the server constructs feature matrices, generates prompt sentences, invokes generative AI models, and structures UI outputs, the computer system itself can be improved to more efficiently transform sensor data and user interaction data into actionable control commands, thereby reducing misoperations and delays in abnormal situations and increasing decision quality and energy efficiency in normal situations.

The specific processing by the specific processing unit 290 of the data processing device 12 in Example 2 is realized by the following means.

The present invention provides a server comprising a processor and a storage device, the processor being configured to acquire environment data including temperature, humidity, power consumption, and cooling equipment operation status from a plurality of measuring devices in a data center, normalize the environment data with time information and device identification information, and store the normalized environment data as environment data records in the storage device; to acquire external environment data including weather information and energy price information from an external information providing apparatus via a communication line, align the external environment data in time with the environment data, and store the aligned external environment data as external environment data records in the storage device; to perform time-direction resampling and statistical aggregation on the environment data records and the external environment data records to construct a feature matrix, to input the feature matrix into a prediction model based on a machine learning algorithm, and to generate prediction results including future energy consumption, energy consumption peak times, and cooling load indices; to acquire operation history data including input operation events, screen transition events, and error occurrence events on a management display apparatus, and to acquire natural language text input via the management display apparatus, to compute behavioral feature values from the operation history data and linguistic feature values from the natural language text by emotion analysis processing, and to input the behavioral feature values and the linguistic feature values into a classification model so as to estimate an emotional state of an operation manager as category information; to generate explanation information summarizing an operating state and future predictions of the data center based on the prediction results and the external environment data records, and to dynamically generate, according to the estimated emotional state, a prompt sentence serving as an instruction sentence to be input to a generative AI model by switching at least a degree of summarization, an output format, and output conditions of the explanation information; to input the prompt sentence into the generative AI model, to acquire from the generative AI model an operation proposal text relating to optimization of cooling and energy efficiency of the data center, and to convert the operation proposal text into structured operation proposal records including procedure information and scenario information stored in the storage device; to control, according to the estimated emotional state, a presentation format, presentation content, and screen configuration of the structured operation proposal records on the management display apparatus, such that, in a high-stress state, a small number of procedure information items having high importance are emphasized and, in a normal state, comparison information of a plurality of scenarios and detailed analysis indices are simultaneously displayed; and to acquire scenario identification information and setting parameters selected by the operation manager on the basis of the presented operation proposal, to verify the setting parameters against predetermined operation constraint conditions, to generate and transmit control commands to at least one of a cooling equipment control system and a power management system, to store control history data representing the control commands and execution results, and to reuse the control history data together with subsequently acquired environment data records, external environment data records, operation history data, and natural language text as learning data to update parameters of the prediction model and the classification model. This enables the computer system to internally adapt its data processing pipeline, prompt sentence generation, generative AI invocation, and user interface presentation to the estimated emotional state of the operator, thereby improving the efficiency and reliability of computer-implemented prediction, recommendation, and control in data center operations, reducing misoperations and response delays under high-stress conditions, and enhancing decision quality and energy efficiency during normal operation.

The term “environment data” refers to information representing physical conditions and equipment operation states inside a data center, including at least temperature, humidity, power consumption, and cooling equipment operation status.

The term “measuring device” refers to a hardware device configured to measure a physical quantity in a data center, such as a temperature sensor, a humidity sensor, a power meter, a flow sensor, or a pressure sensor.

The term “external environment data” refers to information representing conditions outside a data center and market situations, including at least weather information and energy price information obtained from an external information providing apparatus.

The term “storage device” refers to a hardware resource configured to store data persistently or semi-persistently, including at least a non-volatile memory device, a magnetic storage device, a solid-state storage device, or a combination thereof.

The term “environment data record” refers to a data structure stored in the storage device that includes normalized environment data together with associated time information and device identification information.

The term “external environment data record” refers to a data structure stored in the storage device that includes time-aligned external environment data with associated time information. The term “feature matrix” refers to a multi-dimensional data structure in which each row corresponds to a time slice and each column corresponds to a numerical feature derived from environment data and external environment data, and which is used as input to a prediction model. The term “prediction model” refers to a machine-learning model configured to receive a feature matrix as input and to output prediction results, such as future energy consumption values, energy consumption peak times, and cooling load indices.

The term “machine learning algorithm” refers to a computational procedure that learns parameters of a prediction model or a classification model from training data, and includes, for example, neural networks, decision trees, ensemble models, and time-series models.

The term “prediction result” refers to output data generated by the prediction model, including at least future energy consumption, energy consumption peak times, and cooling load indices for one or more future time points.

The term “operation history data” refers to data representing user interactions with a management display apparatus, including at least input operation events, screen transition events, and error occurrence events, each associated with time information and user identification information. The term “behavioral feature value” refers to a numerical or categorical value computed from operation history data, representing characteristics of user behavior, such as a number of clicks, a number of errors, or a frequency of screen transitions.

The term “natural language text” refers to text input by a user in a human language via the management display apparatus, including chat messages, comments, and free-form descriptions. The term “linguistic feature value” refers to a numerical or categorical value computed from natural language text by applying natural language processing and emotion analysis, representing characteristics such as stress level, negativity, or positivity.

The term “classification model” refers to a machine-learning model configured to receive behavioral feature values and linguistic feature values as input and to output category information representing an emotional state of an operation manager.

The term “emotional state” refers to an internal psychological condition of an operation manager estimated by the classification model, represented as category information such as a high-stress state, a normal state, a confused state, or a fatigued state.

The term “explanation information” refers to textual or structured information generated by the processor that summarizes an operating state and future predictions of a data center based on prediction results and external environment data.

The term “prompt sentence” refers to a natural-language instruction sentence dynamically generated by the processor, which is configured to be input to a generative AI model, and which specifies context, constraints, and output requirements for an operation proposal text. The term “generative AI model” refers to an artificial intelligence model configured to receive a prompt sentence and to generate natural-language text as output, the model including at least a parameterized neural network such as a large-scale language model.

The term “operation proposal text” refers to natural-language text generated by the generative AI model in response to a prompt sentence, describing recommended operations for optimizing cooling and energy efficiency in a data center.

The term “structured operation proposal record” refers to a data structure stored in the storage device that represents an operation proposal text in a structured form, including at least procedure information and scenario information.

The term “procedure information” refers to structured data describing one or more operational steps to be executed in a data center, each step including at least an action description and an execution order.

The term “scenario information” refers to structured data describing an operational scenario, including at least parameter settings, predicted energy consumption, predicted cost, and risk-related indices for that scenario.

The term “management display apparatus” refers to an information terminal operated by an operation manager, which includes at least a display unit, an input unit, and communication capabilities, and which is configured to present operation proposals and to receive user input. The term “presentation format” refers to a manner in which operation proposal information is arranged and rendered on the management display apparatus, including layout, level of detail, highlighting, and visibility of components.

The term “screen configuration” refers to a specific arrangement of visual components on a display screen of the management display apparatus, including panels, tables, graphs, and input elements.

The term “high-stress state” refers to an emotional state category in which behavioral feature values and linguistic feature values indicate that an operation manager is under high stress, and for which the system is configured to reduce information density and emphasize urgent steps.

The term “normal state” refers to an emotional state category in which behavioral feature values and linguistic feature values indicate that an operation manager is not under high stress and can process detailed information, and for which the system is configured to present rich comparative information and detailed analysis.

The term “setting parameter” refers to a value representing a configurable operational condition in a data center, such as a temperature target, a fan speed, a scheduling time, or a power limit. The term “operation constraint condition” refers to a rule or boundary used to validate setting parameters, including safety limits, system capability limits, and policy-based restrictions. The term “control command” refers to a structured instruction generated by the processor and transmitted to at least one of a cooling equipment control system and a power management system, the instruction specifying changes to operational parameters or control actions.

The term “control history data” refers to information stored in the storage device that records control commands issued by the system and corresponding execution results, including at least timestamps, target systems, parameters, and success or failure status.

The term “cooling equipment control system” refers to a system configured to control cooling hardware in a data center, including, for example, air conditioning units, fans, pumps, and related actuators.

The term “power management system” refers to a system configured to control or monitor power distribution and power consumption in a data center, including, for example, power distribution units, uninterruptible power supplies, and power monitoring controllers.

The term “learning data” refers to data used to train or update parameters of a prediction model or a classification model, including at least environment data records, external environment data records, operation history data, natural language text, and control history data.

In one embodiment, a system for supporting data center operation includes a server, at least one terminal, and a plurality of measuring devices installed in a data center. The server includes at least one processor, a main memory, a non-volatile storage device, and a network interface. The server executes an operating system such as a general-purpose server operating system, a web application framework such as a general-purpose web framework implemented in a scripting language, a database management system such as a relational database management system, machine learning execution environments such as Python with TensorFlow, PyTorch, and scikit-learn, and a generative AI model runtime either through a client library to an external service or through a local large-scale language model environment. The terminal includes a display unit, an input unit, and a network interface, and executes a general-purpose operating system and a web browser with a front-end application implemented in JavaScript and a web front-end framework. Server stores environment data, external environment data, feature matrices, prediction results, operation history data, user text input, emotion features, emotion state records, operation proposal records, and control history data in logically separated tables or collections in the storage device. Server uses structured schemas for each table. For example, an environment data table includes fields such as timestamp, device_id, data_type, and value. An external environment data table includes fields such as timestamp, outside_temperature, outside_humidity, wind_speed, and energy price. A feature matrix table includes a time key and a fixed-length numeric vector serialized as an array or as multiple columns, each column corresponding to a feature such as average_rack_temperature, total_power, outside_temperature, and normalized_energy_price. An operation history table includes user_id, timestamp, event_type, component_id, page_id, and error_flag. An emotion features table includes user_id, time_window_start, and a set of numeric feature values representing behavioral and linguistic features.

Server acquires raw sensor readings from measuring devices through a sensor gateway. The measuring devices include temperature sensors in racks, humidity sensors in aisles, power meters in power distribution units, and sensors for flow and pressure in cooling circuits. The gateway sends JSON messages over HTTP or a message queue to an ingestion endpoint on the server. Server parses each message, converts units to standardized units, attaches a reception timestamp, and maps a device identifier to a logical sensor type using configuration data stored in the database. Server applies range checks and plausibility checks so that values outside physically possible or configuration-defined ranges are flagged and separated. Server writes valid records into the environment data table and abnormal records into a separate table. This structured normalization enables later time-series processing to be executed efficiently, minimizes the need for repeated validation, and reduces the probability of corrupt or anomalous readings degrading prediction model performance.

Server acquires external environment data using an HTTP client library running in the machine learning environment. Server periodically sends requests to weather information endpoints and energy price information endpoints, receives JSON responses, converts time zones, and aligns all timestamps to fixed sampling intervals using a time-series library such as pandas. Server applies interpolation and forward-fill operations to fill gaps while preserving physical consistency constraints, such as nonnegative prices and temperature within realistic ranges. The aligned external environment data is then stored in the external environment data table. By performing the alignment at the server, the system reduces per-request processing on terminals and eliminates the need for ad-hoc alignment logic in application code, thereby improving overall processing speed and simplifying data management.

Server constructs feature matrices by retrieving environment data and external environment data for a specified historical window and resampling to a common interval. Server calculates statistical aggregates such as mean, maximum, minimum, and standard deviation for power consumption, rack temperatures, humidity levels, cooling device utilization, outside temperature, and price signals. Server may also compute engineered features such as moving averages, exponential moving averages, derivatives (rate of change), and normalized indices (for example, cooling load index normalized by IT load). These features are concatenated into a fixed-length vector per time slice. Server stores these vectors in the feature matrix table. Because the vectors have consistent dimensionality and ordering, a prediction model can read them as tensors with minimal preprocessing, which improves computational efficiency and reduces memory fragmentation in the machine learning runtime.

Server implements prediction models using a machine learning framework such as TensorFlow or PyTorch. In one embodiment, server uses a recurrent neural network with long short-term memory (LSTM) layers. The model architecture includes an input layer receiving sequences of feature vectors for a fixed number of past time steps, one or more LSTM layers converting the sequence into hidden state representations, and one or more fully-connected layers mapping the final hidden state to output values such as future energy consumption at each forecast horizon, a peak indicator, and a cooling load index. Server trains the model offline or periodically online using historical feature matrices and corresponding target labels stored in the database. During training, server uses a loss function such as mean squared error for continuous outputs and cross-entropy for peak classification outputs, and updates weight parameters using an optimizer such as stochastic gradient descent with momentum or an adaptive optimizer. Server may apply regularization techniques such as dropout in LSTM layers and L2 regularization on weights, and may augment training data by injecting noise or random masking into noncritical features to improve robustness.

Server executes inference by loading trained model parameters into memory and constructing input tensors from the most recent rows of the feature matrix table. Server passes these tensors through the model, which performs matrix multiplications, non-linear activations, and recurrent state updates. The resulting outputs are arrays representing predicted energy consumption sequences, predicted peak scores per time step, and predicted cooling load indices. Server post-processes the outputs by identifying time indices with peak scores above a threshold, computing maximum values in the predicted consumption sequence, and summarizing the forecast in human-readable form. These prediction results are written into the prediction result table and used as inputs for prompt sentence generation.

Terminal runs a web browser and loads a front-end application implemented with a general-purpose JavaScript framework. Terminal displays a management dashboard that presents current environment data and prediction summaries using charts and tables. Terminal continuously monitors user actions, including clicks on alarm icons, changes to filter settings, navigation between dashboard pages, and occurrences of input validation errors in configuration dialogs. Terminal associates each event with a timestamp and component identifier, and sends batches of events to the server. Terminal also transmits text typed by the user into chat windows or comment boxes as natural language input along with user identifiers and timestamps.

Server receives operation history data and text input, and computes behavioral and linguistic features for emotion state estimation. For behavioral features, server aggregates log events within sliding time windows per user. Server computes metrics such as number_of_clicks_per_minute, number_of_errors_per_minute, number_of_back_and_forth_page_transitions, average_time_interval_between_clicks, frequency_of_help_or_documentation_access, and duration_of_modal_dialogs. These metrics are normalized across users and time using stored statistics. For linguistic features, server passes each user text message through a pipeline including tokenization, morphological analysis (for example, using a language-specific morphological analyzer), and embedding generation (for example, using a pre-trained transformer-based language model fine-tuned for sentiment analysis). Server obtains intermediate vector representations and feeds them into a sentiment classifier that outputs continuous scores representing stress, negativity, positivity, and confusion. Server aggregates these scores for each user over the same time windows used for behavioral aggregation, producing average scores and variance measures.

Server concatenates behavioral feature vectors and linguistic feature vectors into unified emotion feature vectors and stores them in the emotion features table. Server then applies a classification model configured to estimate emotional state categories. In one embodiment, the classification model is a fully-connected neural network with several hidden layers, each followed by a non-linear activation function such as ReLU. The input layer receives the unified emotion feature vector, the hidden layers learn non-linear combinations of behavioral and linguistic indicators, and the output layer uses a softmax function to produce category probabilities for labels such as HIGH STRESS, NORMAL, CONFUSED, and FATIGUED. During training, server uses labeled emotion examples, calculates cross-entropy loss, and updates model parameters with an optimization algorithm. Server may use class weighting or focal loss to address imbalanced label distributions. Server stores the trained classification model and executes inference periodically for each active user, writing the resulting emotion state records into an emotion state table and caching the latest state for low-latency access.

Server generates prompt sentences for a generative AI model by combining prediction results, summaries of environment data and external environment data, and the latest emotion state for the relevant user. Server constructs textual summaries by formatting predicted peaks, temperature distributions, and device utilization into human-readable sentences. Server maintains multiple prompt templates stored in the storage device, each specifying an instruction structure and output constraints targeted to specific emotion states.

In one example for a high-stress state, server generates the following prompt sentence:

“You are an expert in data center operations.

The administrator is currently under high stress and needs instructions that can be understood in a short time.

Based on the following operational data, present only up to 5 concrete operational steps in bullet form.

Each step must be one sentence, avoid technical jargon, and use plain language.

[Input Data]
Forecast of power consumption peaks over the next 24 hours: {{peak_forecast_summary}}
Current rack-level temperature distribution: {{current_temperature_summary}}
Current cooling equipment utilization: {{current_cooling_status}}

### Output:

A bulleted list of operational steps (up to 5 steps).”

Server replaces placeholders such as {{peak_forecast_summary}} with actual summary strings. In another example for a normal state, server generates the following prompt sentence:

“You are a consultant for data center energy optimization.

The administrator is in a calm state and can understand detailed analysis.

Based on the following data, propose cooling strategies and power-cost minimization strategies for the next 24 hours.

### [Input Data]

Summary of temperature, power, and cooling equipment operation for the past 48 hours: {{historical_data_summary}}

Weather forecast for the next 24 hours: {{weather_forecast_summary}}

Power price forecast for the next 24 hours: {{price_forecast_summary}}

### Output Requirements:

1. Present at least three operational scenarios (e.g., cost-minimized, risk-minimized, and balanced).
2. For each scenario, compare predicted energy consumption and cost in a table.
3. List the graph indicators that should be visualized on the management dashboard.” Server uses a template processing library to assemble the final prompt sentence string. Server then submits the prompt sentence to a generative AI model via an API client or a local inference engine. The generative AI model is implemented as a parameterized neural network such as a transformer-based large language model, where the internal architecture includes an embedding layer, multiple attention layers, and output projection layers. Server configures inference parameters such as maximum token length, sampling temperature, and top-k or top-p sampling thresholds to control the diversity and determinism of generated text.

Server receives the generated operation proposal text and parses it according to structural cues. For high-stress prompts, server splits the response by bullet characters or line breaks to obtain individual steps. For normal-state prompts, server detects headings indicating scenarios, parses tabular data into arrays of cost and energy figures, and extracts references to indicators appropriate for visualization. Server constructs structured operation proposal records that include explicit fields for step_text, scenario_type, predicted_energy, predicted_cost, and recommended graphs. Server stores these structures in the operation proposal table. The use of structured records enables the server to programmatically manipulate the generated proposals, such as sorting steps by urgency or filtering scenarios by constraints, which goes beyond mere presentation of natural language content.

Terminal periodically requests the latest operation proposal and emotion state from the server. Terminal receives structured data and renders different layouts depending on the emotion label. In a high-stress state, terminal hides or collapses panels displaying historical graphs and complex tables, and enlarges a panel labeled “Top Priority Steps” that lists only the most critical steps derived from the structured proposal. Terminal may apply visual emphasis such as colored icons and large fonts to the most urgent action. In a normal state, terminal displays multi-tab panels, where each tab corresponds to a scenario with a comparison table and line charts showing predicted temperature and energy consumption. The terminal UI is realized through a component-based front-end framework that receives JSON data from the server and maps it into visual components. User observes the displayed information and applies proposed operations through the terminal. When the user selects a scenario or confirms new setpoints, terminal packages the chosen scenario identifier and parameter values into a control request and sends it to the server. Server validates the request against operation constraint conditions stored in configuration structures, such as minimum and maximum permissible temperatures, maximum allowable rate of change for fan speeds, and safety margins for power limits. Server rejects requests that violate constraints and returns error messages to the terminal, which are displayed to the user. For valid requests, server constructs control commands in the format required by a cooling equipment control system or a power management system, such as writing to control registers via a fieldbus protocol or invoking an equipment control API. Server sends these commands, monitors acknowledgment responses, and logs successful and failed executions in the control history table together with timestamps and applied parameters.

Server periodically retrains or adjusts both the prediction model and the classification model using updated data. Server forms training datasets from environment data records, external environment data records, prediction results, emotion features, emotion states, and control history. For prediction models, server includes recent control interventions and subsequent environment outcomes, allowing the model to learn changed system dynamics, thereby reducing forecast error over time. For classification models, server uses post-hoc annotations or inferred indicators (for example, improvement or deterioration in interaction patterns after UI adaptation) to refine emotional state classification, thereby improving accuracy in detecting high-stress conditions. Server may apply techniques such as mini-batch training, incremental learning, or transfer learning, depending on computational resources and update frequency. By executing retraining on the server side, the system can improve models without requiring changes to terminals or measuring devices. This configuration produces technical effects in the computer system. By integrating emotion-sensitive prompt sentence generation and UI adaptation, server reduces unnecessary generation of overly long or overly detailed texts in high-stress states, thus reducing network traffic between server and generative AI model, and shortening the time to deliver usable recommendations to the terminal. The structured feature matrix and normalized data schemas reduce preprocessing overhead in the machine learning pipeline, leading to faster inference and more stable memory usage. The emotion state classification based on multi-modal features allows server to dynamically adjust the complexity and volume of data sent to the terminal, reducing rendering load and improving frame rate during critical incidents. The closed feedback loop that uses control history to retrain prediction models improves prediction accuracy, which in turn allows more precise and less conservative control strategies, reducing unnecessary energy consumption while maintaining safety margins.

The use of machine learning and generative AI models in this system is not a mere automation of human procedures. Server internally applies specific numerical algorithms, including sequence modeling with LSTMs, attention-based text encoding, gradient-based optimization with specified loss functions, and feature engineering tailored to sensor data and user behavior logs. These techniques allow the system to extract patterns from high-dimensional time-series and text data that are not practically accessible to human operators. Server uses non-conventional rules for prompt construction, where the content and constraints of the prompt are determined by quantitative thresholds in prediction outputs and emotion features, rather than static templates or simple business rules. For example, server may automatically switch from a multi-scenario template to a five-step emergency template when the predicted peak load exceeds a threshold simultaneously with a high-stress emotion classification, a conjunction that would be difficult to track consistently by manual means.

In alternative embodiments, server may use other neural network architectures for prediction, such as temporal convolutional networks or transformer-based time-series models, and may use other classifiers for emotion state, such as gradient boosting machines or graph-based models that capture relationships between users and sub-systems. Server may integrate additional sensors, such as vibration sensors on equipment or power quality meters, and may incorporate additional external environment data sources, such as grid stability signals or tariff schedules. Server may also adapt the prompt sentence not only based on emotion state but also based on device type or screen size of the terminal, thereby optimizing the content length and level of detail further.

Through these embodiments, server, terminal, and user cooperate in a workflow in which server continuously acquires multi-source data, transforms such data into structured forms suitable for machine learning models, dynamically generates prompt sentences for a generative AI model according to emotion-aware rules, converts generated natural language outputs into structured recommendations, and executes validated control commands on physical equipment. The resulting system improves the underlying computer technology for data processing, prediction, recommendation generation, and user interaction, and ties the abstract computations to concrete control of cooling and power systems in the data center.

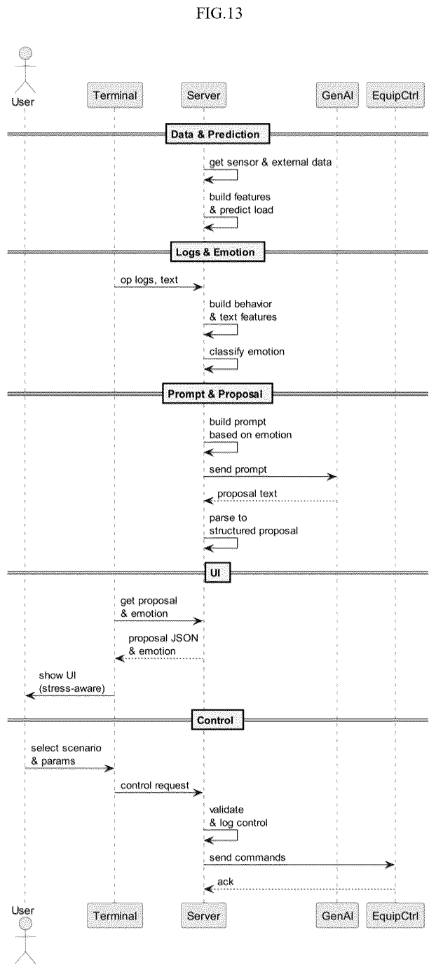

The following describes the processing flow using FIG. 13.

### Step 1:

Server receives and normalizes environment data.

Server uses a network interface and a web application framework to open an HTTP or message-queue endpoint that accepts JSON messages from sensor gateways. The input to this step is a JSON payload that includes, for each measuring device, a device identifier, a raw value, and a measurement timestamp. Server parses the JSON, converts string fields to numeric values, and attaches a server-side reception timestamp. Server looks up each device identifier in a configuration table stored in a relational database to determine a logical sensor type (for example, rack_temperature, room_humidity, pdu_power, chiller_status) and a corresponding data_type. Server performs data processing by checking each numeric value against minimum and maximum thresholds and by discarding or flagging values that are physically impossible. The output of this step is a set of normalized environment data records, each including time, device_id, data_type, and value. Server writes valid records into an environment data table in a storage device and writes abnormal records into an abnormal data table.

### Step 2:

Server acquires and aligns external environment data.

Server executes a scheduled task in a scripting environment to periodically call external APIs. The input to this step is a set of API endpoints for weather and energy prices and associated authentication tokens. Server sends HTTP GET requests, receives JSON responses containing weather forecasts and price forecasts, and parses time stamps, temperature, humidity, wind speed, and price fields. Server uses a time-series library to convert all timestamps to a standard time zone and to round them to fixed intervals, such as every 15 minutes. Server performs data processing by interpolating missing time points and clamping outliers to acceptable ranges defined in configuration. The output of this step is a sequence of time-aligned external environment data records, each including timestamp, outside_temperature, outside_humidity, wind_speed, and energy price. Server stores these records in an external environment data table.

### Step 3:

Server constructs unified feature vectors for prediction.

Server periodically retrieves environment data records and external environment data records for a predefined historical time window, such as the last 48 hours. The input to this step is a set of rows from the environment data table and external environment data table, filtered by time range. Server uses a data processing library to resample each time series to a common resolution, such as 1-minute or 5-minute intervals. Server performs data processing by aggregating multiple readings within each interval and computing statistics such as average rack temperature, maximum rack temperature, total power consumption, average humidity, average outside temperature, and average energy price. Server concatenates these statistics into a numeric feature vector for each time interval, ensuring that all vectors have the same order of features. The output of this step is a collection of feature vectors indexed by timestamp, which server stores in a feature matrix table.

### Step 4:

Server performs prediction of energy consumption and cooling load.

Server loads a trained prediction model from the storage device into a machine learning runtime. The input to this step is an ordered sequence of recent feature vectors from the feature matrix table, covering a fixed number of past time intervals. Server reshapes the sequence into a tensor with dimensions suitable for the prediction model, such as [batch_size, sequence_length, feature_dimension]. Server performs data computation by running the tensor through a neural network, such as a long short-term memory network, where each layer multiplies the tensor by weight matrices, adds biases, and applies non-linear activation functions. The network outputs predicted energy consumption for future time steps, peak indicators, and cooling load indices. Server post-processes these outputs by identifying the maximum predicted consumption, the time of peak consumption, and summarized cooling load values. The output of this step is a set of prediction result records, each including future_timestamp, predicted_power, predicted_peak_flag, and cooling_load_index, which server writes into a prediction result table.

### Step 5:

Terminal collects and sends operation history data.

Terminal executes a JavaScript front-end application in a web browser. The input to this step is user interaction with the dashboard interface, including clicks, button activations, navigation between pages, and form validation errors. Terminal uses event listeners to capture each event, associates it with the current time, user identifier, page identifier, and component identifier, and appends it to an in-memory buffer of logs. Terminal performs data processing by batching multiple events into a JSON array when a time interval elapses or a threshold number of events is reached. The output of this step is a batch of operation history events. Terminal sends this batch to the server over HTTP or WebSocket, and server writes each event as a row in an operation history table.

### Step 6:

Terminal captures and transmits natural language text input.

Terminal displays input fields for chat and comments in the dashboard. The input to this step is text that the user types and confirms by pressing a send button. Terminal attaches metadata such as user_id, page_id, and a client-side timestamp to the text. Terminal performs simple data processing by trimming leading and trailing spaces and limiting the length of the text to a configured maximum. The output of this step is a structured message object including text and metadata. Terminal sends this message object to the server via an HTTP POST request, and server stores each message as a record in a user text input table for later analysis.

### Step 7:

Server computes behavioral and linguistic features for emotion estimation.

Server periodically reads operation history records and text input records for each active user over a sliding time window, such as the last 5 minutes. The input to this step is a set of logs and messages associated with a user_id and a time range. Server aggregates the operation history by user and window, computing behavioral metrics such as total_clicks, error_count, back_and_forth_transitions, mean_inter_click_interval, and help_access_count. Server processes natural language text by tokenizing sentences, performing morphological analysis with a language-specific toolkit, and converting tokens into embeddings using a pre-trained language model. Server passes these embeddings through a sentiment analysis component to compute numeric scores for stress, negativity, and positivity for each message, and then averages these scores over the time window. Server performs data processing by concatenating behavioral metrics and aggregated sentiment scores into a unified feature vector. The output of this step is a set of emotion feature records containing user_id, time_window_start, and the feature vector, which server writes into an emotion features table.

### Step 8:

Server classifies the emotional state of the user.

Server loads a trained classification model from the storage device. The input to this step is the latest emotion feature vector for each user from the emotion features table. Server performs data computation by passing the feature vector through the layers of the classification model, such as a feed-forward neural network, which multiplies the input by weight matrices, adds biases, and applies activation functions to produce logits for each emotional category. Server applies a softmax function to convert logits into probabilities for states such as HIGH_STRESS, NORMAL, CONFUSED, and FATIGUED. Server selects the category with the highest probability and records this as the estimated emotional state, along with the probability value as a confidence score. The output of this step is an emotion state record including user_id, emotion_label, confidence, and timestamp, which server writes into an emotion state table and caches in memory for quick access.

### Step 9:

Server generates an emotion-aware prompt sentence for a generative AI model.

Server retrieves the latest prediction results, environment summaries, and external environment summaries for a given time horizon. The input to this step is prediction result records, aggregated environment data, aggregated external environment data, and the current emotional state of the user from the cache. Server performs data processing by transforming numerical prediction and measurement values into descriptive text, such as “A power consumption peak of approximately 850 kW is expected between 14:00 and 15:00.” Server selects a prompt template according to the emotional state: a concise, step-based template for HIGH_STRESS and a detailed, scenario-based template for NORMAL. Server fills placeholders in the chosen template with the descriptive text snippets using a template engine, thereby constructing a full natural-language prompt sentence. The output of this step is a single prompt sentence string configured for input into a generative AI model.

### Step 10:

Server invokes the generative AI model and structures the operation proposal.

Server uses an API client to send the prompt sentence to a generative AI model endpoint. The input to this step is the prompt sentence and optional generation parameters, such as maximum token count and sampling temperature. Server transmits the request over HTTPS and waits for the response, which includes generated natural-language text representing an operation proposal. Server performs data processing by parsing the returned text: for a high-stress prompt, server splits the text into bullet points or lines to obtain individual steps; for a normal-state prompt, server searches for scenario headings, extracts tabular data for energy consumption and costs, and identifies recommended visualization indicators. Server converts the parsed content into structured records with fields such as step_text, scenario_type, predicted_energy, predicted_cost, and recommended_graphs. The output of this step is a structured operation proposal object, which server stores in an operation proposal table.

### Step 11:

Terminal renders the operation proposal according to the emotional state.

Terminal periodically requests updated operation proposals and emotion state from the server. The input to this step is a JSON response containing the structured operation proposal and the current emotion_label. Terminal performs data processing by selecting a layout configuration based on the emotion label. For a HIGH_STRESS state, terminal hides non-essential components, such as long historical charts, and arranges a single central panel displaying only the most critical steps from the step_text fields. For a NORMAL state, terminal creates multiple tabs or panels, each displaying scenario_type, predicted_energy, predicted_cost in tables, and recommended graphs as charts. Terminal maps structured fields to UI components and updates the DOM in the browser. The output of this step is a rendered dashboard screen that visually adapts to the emotional state.

### Step 12:

User selects and confirms an operation scenario.

User views the rendered dashboard on the terminal. The input to this step is the displayed operation proposal, including steps and scenarios. User interacts with UI elements such as radio buttons, dropdowns, and sliders to choose a scenario and adjust settings, for example, selecting a cost-optimized scenario and modifying a target temperature. User then presses a confirmation button such as “Apply Settings.” Terminal captures the selected scenario identifier and associated parameter values. Terminal performs data processing by packaging these selections into a control request object with user_id, scenario_id, and parameters. The output of this step is a structured control request, which terminal sends to the server via an HTTP API.

### Step 13:

Server validates control requests and issues control commands.

Server receives the control request from the terminal. The input to this step is a JSON object containing scenario_id, parameter values, and user_id. Server looks up operation constraint conditions in configuration tables, such as allowable temperature ranges and maximum permissible changes per unit time. Server performs data processing by verifying that each requested parameter value satisfies all corresponding constraints and that the requesting user has sufficient privileges. If validation fails, server generates an error response describing the violated condition; if validation succeeds, server translates abstract parameters into concrete control commands in the protocol required by the cooling equipment control system or power management system. Server sends these commands over appropriate interfaces and waits for acknowledgments. The output of this step is a success or failure result for each command and a set of control history records, including timestamps, target devices, parameter values, and execution status, which server stores in a control history table.

### Step 14:

Server updates models using accumulated data.

Server periodically initiates a retraining or fine-tuning process for the prediction model and the classification model. The input to this step is accumulated environment data records, external environment data records, prediction results, emotion features, emotion states, and control history data from the storage device. Server constructs training datasets by pairing input sequences of feature vectors with target values such as actual measured consumption and realized peaks for the prediction model, and by pairing emotion feature vectors with emotion labels or proxy labels for the classification model. Server performs data computation by loading these datasets into the machine learning runtime, computing loss values such as mean squared error and cross-entropy, and updating model weights through gradient descent and backpropagation. Server evaluates updated models on validation datasets and, if performance improves, replaces previous model versions and stores the new parameters. The output of this step is a set of updated model parameter files and improved predictive and classification performance in subsequent runs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional energy and facility operation systems typically optimize based on a limited set of physical and economic metrics, such as power consumption, temperature, and energy prices.

These systems may employ rule-based control logic or static scheduling, and more recent approaches may incorporate machine learning models to forecast demand. However, such systems generally treat user behavior and user experience as exogenous factors or ignore them altogether. In particular, conventional systems do not robustly incorporate user emotion states or user feedback into the computation of operation plans. As a result, operation strategies that appear optimal from an energy-efficiency perspective can inadvertently degrade user comfort or satisfaction, leading to complaints, reduced service usage, or the need for manual overrides.

Furthermore, conventional architectures typically separate the analytics pipeline from any generative artificial intelligence model that could assist in designing control logic, screen layouts, or multi-objective strategies. Existing systems may use predictive models to estimate future load, but they lack a tightly coupled mechanism to (i) generate structured, context-rich prompt sentences from real-time, multi-modal city or facility data, (ii) feed such prompts into a generative AI model, and (iii) automatically integrate the generative AI output with mathematical optimization results. As a consequence, administrators must manually interpret analytic dashboards, design control policies, and configure interfaces. This manual loop is time-consuming, error-prone, and difficult to adapt dynamically to changing conditions.

In addition, typical emotion estimation mechanisms, when present, operate in a single layer, either entirely at the terminal side or entirely at the server side, and do not effectively leverage a cooperative multi-stage estimation that combines lightweight on-device inference, user self-report, and higher-accuracy server-side models. Without such a pipeline, emotion indices used by the system are often noisy or biased, undermining the reliability of any optimization that attempts to consider user comfort together with energy efficiency.

Moreover, in many existing architectures, user feedback on implemented operation measures is not systematically captured and reintegrated into the analytical and optimization processes. Feedback, if collected at all, is often stored as free-form text or coarse survey results that are not closed-loop connected to the models that generate operation plans. This prevents the system from improving over time in a data-driven manner.

Accordingly, there is a need for an improved computer-implemented system that: (i) acquires and integrates time-series data from heterogeneous sources including environmental states, equipment states, and user states; (ii) performs multi-stage, multi-modal emotion estimation that fuses terminal-side inference, self-report data, and server-side models into a corrected emotion index; (iii) computes operation plans via machine learning and mathematical optimization that jointly consider energy efficiency indices and emotion indices; (iv) automatically generates prompt sentences from integrated feature data and emotion indices, and uses a generative AI model to propose refined operation policies, control parameters, and display configurations; and (v) closes the loop by visualizing measures, collecting administrator feedback, and feeding this feedback back into the data management and analytics pipeline. Such a system would improve the functioning of the underlying computer technology by enabling more adaptive, automated, and human-aware control of complex environments, while reducing manual configuration and improving scalability and responsiveness of the overall platform.

The specific processing by the specific processing unit 290 of the data processing device 12 in Application Example 2 is realized by the following means.

The present invention provides a server comprising a processor and a memory storing instructions which, when executed by the processor, cause the processor to acquire time-series information related to environmental states, equipment states, and user states from multiple detection units; store the time-series information together with external information including weather information and energy transaction information in a storage device as time-series records, and aggregate and integrate the time-series records on a time basis and an area basis to generate integrated feature data; estimate a user emotion state based on audio information, image information, position information, operation history information, and self-report information obtained from terminal devices, and calculate an emotion index by performing a weighted integration of an estimation result of the user emotion state and the self-report information; execute machine learning processing and mathematical optimization processing using, as input, energy consumption information, environmental state information, traffic state information, the external information, and the emotion index, and calculate a demand forecast and an operation plan that simultaneously take into account an energy efficiency index and the emotion index; convert at least a part of the integrated feature data, the emotion index, and the operation plan into natural language text to generate a prompt sentence, input the prompt sentence into a generative artificial intelligence model, and acquire proposal information relating to at least one of the operation plan, a control parameter, and a display configuration; integrate the operation plan calculated by the machine learning processing and the mathematical optimization processing with the proposal information acquired from the generative artificial intelligence model, determine operation measures including predicted changes of the energy efficiency index and the emotion index, and generate structured information representing the operation measures and transmit the structured information to a management terminal; and cause an interface on the management terminal to visualize, based on the structured information, at least an energy usage situation, the emotion index, the operation measures, and predicted effects thereof for each area, accept an approval input, a modification input, and a feedback input from a user, and reflect the feedback input in at least one of the stored time-series records and parameters used in the machine learning processing. This enables an integrated computer-implemented control framework in which heterogeneous sensor data, multi-stage emotion estimation, predictive analytics, mathematical optimization, and generative AI model outputs are combined to automatically generate, refine, and present operation measures that jointly optimize energy efficiency and user comfort, while continuously improving system behavior through feedback, thereby enhancing the technical performance, adaptability, and automation of the underlying information processing infrastructure.

The term “time-series information” refers to information that includes values of one or more variables associated with timestamps, and that is collected, stored, or processed in chronological order so that temporal changes in environmental states, equipment states, or user states can be analyzed.

The term “environmental state” refers to a condition of a physical environment in a managed facility or area, including at least one of temperature, humidity, noise level, illuminance, air quality index, or similar measurable environmental quantities.

The term “equipment state” refers to an operational condition of one or more devices or systems in a managed facility or area, including at least one of power consumption, operating mode, on/off status, setpoint value, or performance metric of equipment such as lighting, heating, ventilation, air conditioning, or transportation infrastructure.

The term “user state” refers to a condition associated with an individual or a group of individuals in a managed area, including at least one of presence, location, interaction behavior, operation history, self-reported evaluation, or emotion state.

The term “detection unit” refers to any combination of hardware and software that is configured to sense, measure, or collect information, including at least one of a physical sensor, a terminal device, or an application program that acquires audio information, image information, position information, operation history information, or self-report information.

The term “external information” refers to information obtained from a source outside a managed facility or area, including at least one of weather information, energy transaction information, market information, or other externally provided data that influences operation planning.

The term “weather information” refers to information indicative of a meteorological condition in a region, including at least one of air temperature, humidity, wind speed, precipitation, solar radiation, or weather forecast data.

The term “energy transaction information” refers to information relating to transactions in an energy market, including at least one of energy price, supply-demand balance, or traded quantity for electricity, gas, or other energy resources.

The term “time-series record” refers to a data record that includes at least one timestamp and at least one value of a variable, and that is stored in a storage device in a form that enables chronological retrieval and aggregation.

The term “integrated feature data” refers to data obtained by aggregating and combining multiple time-series records on a time basis and an area basis, and by computing statistical or derived quantities that represent an integrated state of environmental, equipment, and user-related variables. The term “terminal device” refers to a computing apparatus operated or carried by a user, including at least one of a mobile communication device, a portable information device, or a fixed information device, that comprises a processor, a display, an input unit, and a communication unit, and that executes an application program to acquire and transmit user-related information. The term “audio information” refers to digital data representing sound, including at least one of raw audio signals, encoded audio streams, or features extracted from audio signals such as volume, pitch, or spectral characteristics.

The term “image information” refers to digital data representing a still image or a sequence of images, including at least one of raw pixel data, encoded image data, or features extracted from images such as facial features or expression-related features.

The term “position information” refers to information indicative of a spatial position of a detection unit or a terminal device, including at least one of geographic coordinates, region identifiers, building identifiers, or floor numbers.

The term “operation history information” refers to information representing operations performed by a user on a terminal device or system, including at least one of screen transitions, button activations, input operations, dwell times, or interaction sequences.

The term “self-report information” refers to information explicitly entered by a user to express a subjective evaluation, including at least one of a rating value, a selected option, or a free-form text describing a mood, comfort level, or satisfaction level.

The term “user emotion state” refers to a psychological condition of a user expressed in terms of an emotion category or a numerical score, including at least one of comfort, discomfort, stress, joy, anger, sadness, or anxiety.

The term “emotion index” refers to a numerical value representing an emotion-related characteristic of at least one user or group of users, derived from at least one of an estimated user emotion state and self-report information, and usable as an input to prediction or optimization processing.

The term “energy efficiency index” refers to a numerical value indicative of efficiency or environmental impact of energy usage, including at least one of energy consumption per service unit, peak power, energy cost, or emission amount.

The term “machine learning processing” refers to a computational process executed by a processor according to instructions that implement a learning algorithm or an inference algorithm, including at least one of regression, classification, clustering, or time-series prediction, in order to model or predict relationships between input variables and output variables.

The term “mathematical optimization processing” refers to a computational process that formulates an objective function and one or more constraints based on input data, and that determines variable values that minimize or maximize the objective function while satisfying the constraints, including at least one of linear programming, nonlinear programming, or integer programming.

The term “demand forecast” refers to a prediction of a future quantity related to resource usage or service usage, including at least one of future energy consumption, future traffic volume, or future aggregated emotion index.

The term “operation plan” refers to a set of values or rules specifying how equipment or systems should be controlled over a time horizon, including at least one of setpoints, schedules, and control parameters for equipment in a managed facility or area.

The term “prompt sentence” refers to natural language text generated by the system that includes at least one of integrated feature data, an emotion index, and information relating to an operation plan, and that is configured as input to a generative artificial intelligence model to cause the generative artificial intelligence model to output proposal information.

The term “generative artificial intelligence model” refers to an artificial intelligence model trained with data and parameters such that, given one or more inputs including at least a prompt sentence, the model generates an output comprising natural language text, structured data, or design proposals for operation plans, control parameters, or display configurations.

The term “proposal information” refers to information produced by a generative artificial intelligence model in response to a prompt sentence, including at least one of a suggested operation plan, a suggested control parameter value, or a suggested display configuration.

The term “operation measure” refers to a concrete control action or combination of actions to be applied to equipment or systems in a managed facility or area, derived from at least one of an operation plan and proposal information, and including predicted effects on an energy efficiency index and an emotion index.

The term “structured information” refers to information represented in a format having an explicit structure, including at least one of a record, a table, or a hierarchical representation, which can be programmatically interpreted and processed by a terminal or server.

The term “management terminal” refers to a computing apparatus operated by an administrator or operator and configured to receive structured information from a server, display visualizations of operation measures and states, and accept user inputs related to approval, modification, or feedback.

The term “interface” refers to a combination of hardware and software elements provided on a management terminal that presents visual or auditory output to a user and receives input from the user, including at least one of a graphical user interface, a command interface, or a form-based interface.

The term “approval input” refers to user input that indicates consent to apply one or more proposed operation measures, including at least one of a confirmation operation, a selection of a proposed measure, or a positive rating.

The term “modification input” refers to user input that indicates a change to one or more parameters of a proposed operation measure, including at least one of adjustment of a numerical value, selection of a different option, or editing of a schedule.

The term “feedback input” refers to user input that provides information about a result or perception of an applied operation measure, including at least one of a qualitative comment, a rating, or a selection indicating improvement or deterioration of comfort or satisfaction.

The term “integrated feature data” (as used in connection with the prompt sentence and generative artificial intelligence model) refers to aggregated and processed values that summarize, for a time period and an area, the states of environmental variables, equipment variables, and user-related variables, and that serve as features for machine learning processing and as content for natural language representation.

The term “corrected emotion index” refers to an emotion index that has been refined by combining an integrated emotion score derived from terminal-side processing and self-report information with an additional estimation result computed by a higher-accuracy server-side model, using a fusion rule to reduce noise or bias.

The term “operation logic” refers to a rule set or algorithmic structure that defines how operation measures are determined or adapted in response to state variables, forecasts, or user-related indices, and that can be generated or refined based on generative artificial intelligence model output.

In one embodiment, a server, one or more terminals, and one or more users cooperate to implement the claimed system. The following description illustrates exemplary hardware and software configurations, data structures, algorithms, and interaction patterns that allow a person skilled in the art to implement the invention.

A. System architecture (hardware and software)

The server is implemented as a general-purpose computing apparatus, such as a rack-mounted computer or a virtual machine in a cloud environment. The server includes at least one processor, a main memory, a non-volatile storage device, and a network interface. The server executes an operating system such as a server-class operating system, and runs middleware including a web server, an application framework, and a database management system.

The server executes web server software (for example, a reverse proxy server) to terminate HTTPS connections from terminals and management terminals. The server executes an application framework (for example, a Python-based web framework) that provides RESTful APIs for data ingestion, control, and visualization. The server further executes a relational database management system, such as a relational engine with a time-series extension, to store time-series records. In some embodiments, the server additionally uses a time-series database engine (for example, a log-structured merge-tree based store) for high-frequency sensor data.

Each terminal is implemented as a mobile or fixed computing device, such as a smartphone, tablet, portable computer, or workstation. The terminal includes a processor, memory, a display, a user input device (touch panel, keyboard, or pointing device), a microphone, a camera, a wireless communication module (cellular or wireless local area network), and a position-detection module (for example, a satellite positioning receiver or network-based positioning). The terminal executes a mobile or desktop operating system and runs an application program dedicated to this system. The application program on the terminal is written using a graphical user interface framework suitable for the operating system (for example, a declarative UI framework for mobile systems). The terminal-side application integrates an event logging library, a location service client (for example, an operating-system native fused location provider or core location framework), a camera capture API, a microphone capture API, and optionally a lightweight model inference engine such as an ONNX runtime for mobile devices.

A management terminal is implemented as a general-purpose computer or tablet with a web browser. The management terminal accesses the server's dashboard web application implemented using a client-side JavaScript framework (for example, a component-based front-end library) and a visualization library (for example, a charting and mapping library).

B. Data structures and storage

The server stores time-series records in tables or collections having explicit schema. In one embodiment, the server defines tables as follows:

(1) An emotion_log table, storing:
a timestamp (for example, stored as a time with time zone type),
an area identifier (for example, a text or numeric identifier),
a hashed user identifier (for example, a fixed-length string produced by a secure hash function applied to a user token),
an emotion label (for example, a categorical string such as “joy”, “stress”),
an emotion score (for example, a floating-point value in [0,1]),
a self-reported mood value (for example, an integer in a discrete range),
an activity log (for example, a structured field encoded as a hierarchical document storing screen identifiers, tap counts, and dwell times).

(2) An energy_usage table, storing:
timestamp,
area identifier,
power consumption value,
equipment category, and optional additional parameters.

(3) A traffic_state table, storing:
timestamp,
area identifier,
traffic volume,
average speed, and congestion indicators.

(4) An environment_state table, storing:
timestamp,
area identifier,
temperature, humidity, noise level, illuminance, and similar values.

(5) A weather table, storing external weather information (for example, forecasted and observed temperature, humidity, wind speed, precipitation).

(6) An energy_market table, storing external energy transaction information (for example, current and forecasted prices and market conditions).

The server defines a view or materialized view named city_state_features that aggregates these tables by area identifier and time bucket. The server uses a time-bucketing function in the database extension to group records into fixed-duration intervals (for example, 15 minutes or 1 hour). For each area and each time bucket, the server computes:
average or total power consumption,
average traffic volume and congestion index,
average temperature and other environmental metrics,
average energy price,
average emotion score,
counts or distributions of emotion labels.

By defining such a view, the server realizes a standardized feature vector structure for machine learning models and also a compact representation for prompt sentence generation.

C. Terminal-side data processing and emotion estimation

The terminal acquires position information by calling an operating system location API such as a fused location provider or a core location service. The terminal receives raw latitude, longitude, and timestamp data. The terminal then applies a rounding operation to the latitude and longitude values based on a user-selected precision level. For example, if the user has selected a “district-level” precision, the terminal truncates latitude and longitude to three decimal places. This rounding reduces the granularity of positional data and thus reduces privacy risk, while still providing sufficient spatial resolution for area-level analysis.

The terminal collects operation history information by registering handlers for user interface events (for example, screen appears, button tapped, input confirmed). The terminal accumulates, in memory, per-screen counters such as tap count and dwell time. At periodic intervals, the terminal aggregates and resets these counters, producing an activity log structure for each interval. The terminal acquires audio information via a microphone API by recording short segments in linear PCM format at 16 kHz. The terminal computes audio features such as:
short-time energy (for example, root-mean-square amplitude per frame),
fundamental frequency (for example, via autocorrelation or spectral-based pitch detection),
spectral centroid and spectral bandwidth.

The terminal constructs a fixed-length audio feature vector by averaging or otherwise combining per-frame values over a recording window. The terminal then passes this vector to an on-device classifier. In one embodiment, the classifier is a small fully connected neural network exported to an ONNX model. The network may consist of an input layer, two or more hidden layers with rectified linear activation units, and an output softmax layer providing probabilities for discrete emotion-related voice states (for example, “calm”, “stressed”, “angry”). The terminal selects the label with maximum softmax probability as a voice-based emotion label and uses the corresponding probability as a voice-based emotion score.

The terminal acquires image information from a front-facing camera via a camera capture API. The terminal passes frames to a face detection library, which returns coordinates of faces. For each face region, the terminal performs resizing and normalization to feed the image into an on-device facial expression model, again exported to an ONNX format. The facial expression model can be a convolutional neural network with multiple convolutional and pooling layers, followed by fully connected layers and a softmax output over expression categories. The terminal obtains per-category probabilities for expressions such as “joy”, “sadness”, “anger”, “surprise”, and “neutral”, and derives a face-based emotion label and a face-based emotion score.

The terminal fuses the voice-based and face-based scores into a sensor-derived score. For example, the terminal computes a weighted average of the two scores when both are present. The terminal also presents a self-report interface (for example, a slider with discrete values) and receives a self-reported mood value. The terminal converts this value to a normalized score by dividing by the maximum rating. The terminal then computes a combined emotion score using a linear combination:
combined_score=α×sensor_score+(1−α)× self_report_score, where α is a configurable parameter. This explicit formula constitutes a deterministic and repeatable rule, different from ad hoc or purely manual assessment methods. The terminal thus transforms multiple heterogeneous inputs into a unified, bounded value that can be reliably processed on the server side.

By performing these computations on the terminal, the system reduces uplink bandwidth (because raw audio and video can be discarded or compressed after feature extraction) and improves response time for emotion-related interactions. The combination of edge-side pre-processing and server-side refinement (described below) leads to a technical improvement in computation distribution and communication efficiency.

### D. Server-Side Multi-Stage Emotion Refinement

The server receives combined emotion scores and optional feature-level data from the terminals. In some embodiments, the server also receives de-identified audio segments for further analysis. The server loads a high-capacity neural network model for emotion recognition, such as a model based on a deep convolutional or transformer-like architecture trained on large-scale emotional speech or facial datasets. The model may accept as input either raw waveforms or spectral representations and produce refined emotion scores for continuous dimensions such as valence and arousal, and for discrete categories.

The server computes a corrected emotion index by fusing the terminal-computed combined score with the model's refined output. In one example, the server trains a calibration network, which is a shallow neural network that takes as inputs the terminal score, the server model's scores, and contextual features (for example, time of day or area type) and outputs a single corrected emotion index in the range [0,1]. The calibration network is trained offline using historical data and a loss function such as mean squared error between predicted indices and ground-truth indices derived from crowd-sourced labels or detailed surveys.

The server updates emotion_log entries with the corrected emotion index. Through this multi-stage pipeline, the system achieves higher accuracy and robustness than a single-stage estimation mechanism. The two-level architecture also allows the server to use more complex models that would be impractical to run on a battery-powered terminal, thereby improving overall system performance while respecting client resource constraints.

E. Predictive analytics and optimization

The server uses the city_state_features view as a feature store for predictive models. The server extracts feature vectors for each area and time bucket, including:
numerical values (for example, normalized power consumption, traffic volume, temperature, energy price, corrected emotion index),
time features (for example, day of week encoded as a one-hot vector, time of day encoded as cyclic functions such as sine and cosine),
area descriptors (for example, one-hot or embedding representations of area categories).

In one embodiment, the server trains a recurrent neural network (for example, a long short-term memory network) that accepts sequences of such feature vectors and outputs predicted future sequences for power demand and emotion indices. The server uses a loss function such as mean squared error or mean absolute error between predicted and actual time-series values and trains the network using gradient-based optimization (for example, stochastic gradient descent with adaptive learning rate). The server may augment training data via time-window sampling and noise injection to improve generalization.

In another embodiment, the server employs gradient-boosted decision tree models for short-horizon predictions, using a training algorithm that iteratively adds trees to minimize an objective function combining prediction error and tree complexity. This structure is well-suited for handling mixed numerical and categorical features.

The server outputs forecasts for each area and time bucket, including predicted power demand, predicted traffic volume, and predicted emotion indices. The server then formulates a mathematical optimization problem. The server defines decision variables representing, for example:
brightness ratios for lighting systems in each area and time bucket,
adjustments to heating or cooling setpoints,
changes in transportation schedules (for example, multipliers for bus or train frequency),
priority factors for signal timing at intersections.

The server defines an objective function that includes weighted components:
a term representing total energy cost (for example, sum of power consumption multiplied by energy price across all areas and time buckets),
a term representing environmental impact (for example, a function proportional to aggregate energy use or emission factors),
a term representing emotion-related discomfort (for example, sum of (1-predicted emotion index) across areas and times).

The server uses a mathematical programming solver to determine values of the decision variables that minimize the objective function while satisfying constraints such as:
equipment operation limits (for example, minimum and maximum setpoints),
safety and regulatory constraints,
resource capacity constraints (for example, maximum number of vehicles available).

The explicit formulation of a multi-objective optimization that incorporates an emotion index is a technical extension beyond conventional energy-only optimization. The use of standardized feature vectors and predicted emotion trajectories enables the solver to operate on quantifiable human-state data.

F. Prompt sentence generation and generative AI collaboration

The server constructs prompt sentences to query a generative AI model. The server accesses the city_state_features view and additional statistical summaries (for example, recent anomalies or patterns). The server converts numerical values into text snippets. For example, when average power consumption in one area is high and the emotion index is low, the server generates text such as:

“Area A currently has an average power consumption of 1200 kilowatts and an average emotion score of 0.45, indicating high stress.”

The server concatenates these snippets with instruction text defining the task for the generative AI model. In one example, the server composes the following prompt sentence: “Using the following city data, propose an operation policy that considers both energy efficiency and user emotions.

Area A: average power consumption 1200 kW, average emotion score 0.45 (high stress) Area B: average power consumption 900 kW, average emotion score 0.80 (comfortable) Current electricity price: 30 currency units per kilowatt-hour

Tomorrow's temperature forecast: high 35 degrees, low 27 degrees Please present concrete adjustment measures for lighting, air conditioning, and public transport operations that will reduce peak energy consumption while improving Area A's emotion score to at least 0.60.”

In another example, the server constructs a prompt sentence focusing on system design:

“The structure of city data for energy, traffic, weather, energy price, and user emotions is as follows:

Table city_state_features (time, area_id, power_consumption, traffic_volume, temperature, energy_price, avg_emotion_score)

Using this data, please propose:
1) An AI model architecture for predicting peak power consumption and traffic congestion;
2) An optimization logic that simultaneously minimizes energy cost and emotional discomfort;
3) A management dashboard layout (map view, charts, alerts, etc.).”

The server sends the prompt sentence to the generative AI model running on a separate inference service or platform. The generative AI model is a large language model trained with sequence-to-sequence or decoder-only architectures that use attention mechanisms to generate context-dependent text. The server configures generation parameters such as maximum token length, temperature, and sampling strategy (for example, top-k or nucleus sampling). The model produces proposed operation policies, alternative visual layouts, or descriptions of control logic.

The server analyzes the model's output using text parsing algorithms. For instance, the server uses pattern matching to detect words like “reduce lighting by 20% in Area A” and extracts structured values (area identifier, control type, magnitude). The server also computes consistency checks between the generative output and optimization constraints, discarding or adjusting suggestions that violate hard constraints.

This collaboration between optimization and generative AI provides a technical effect: the combination allows the system to explore non-trivial operational strategies that may not be easily encoded as conventional rules, and to generate alternative user interface designs that improve human comprehension and decision speed. The explicit data structures (prompt sentences and parsed proposals) and the controlled integration back into the optimization pipeline ensure that this is not a mere automation of human reasoning but a specialized computational mechanism designed to search a large solution space efficiently.

### G. Visualization and Feedback Integration

The server transmits structured operation measures and their predicted effects to management terminals through web APIs. The management terminal, using its browser and front-end framework, renders:
maps color-coded by emotion index and power usage,
time-series graphs of historical and forecasted metrics,
tables listing each operation measure (for example, “lighting reduction 20% in Area A from 18:00 to 21:00”).

The user (for example, a facility manager or city operator) views these displays and provides inputs such as approving specific measures, modifying parameter values, or adding comments about perceived impact. The terminal sends these inputs back to the server as structured feedback records, including, for example:
a reference to the measure identifier,
a status (approved, modified, rejected),
a subjective rating,
textual comments.

The server stores this feedback in association with the corresponding measures and time periods. The server may use these feedback records as additional training data to update the calibration network for emotion index, to adjust weights in the optimization objective function, or to generate new prompt sentences that summarize past successes and failures.

### H. Technical Advantages and Improvements

The described system provides multiple technical improvements over conventional systems:
(1) Improved accuracy and robustness of emotion indices: The multi-stage architecture, which combines terminal-side inference, user self-report, and server-side high-capacity models, reduces noise and bias in estimation. This enables more reliable downstream optimization and forecasting, which would not be possible using only a single-stage or human-only assessment.
(2) Increased computational efficiency: By placing lightweight inference and feature extraction on terminals, and heavier modeling on the server, the system reduces uplink data volumes and balances computational load. This partitioning reduces latency in interactive tasks and reduces energy consumption on mobile devices.
(3) Enhanced data management: The explicit use of time-series schemas, bucketed aggregation, and integrated feature views improves query performance and simplifies feature extraction. The database-level integration of multiple data sources (environmental, operational, emotional, and external) enables complex analytics that would be inefficient with ad hoc data structures.
(4) Non-conventional optimization logic: The system explicitly formulates optimization with an emotion index term in the objective function, combining physical and psychological metrics. Conventional systems do not encode such indicators directly, and instead rely on static rules or manual tuning. The claimed approach extends the technical capabilities of optimization engines to new multi-dimensional criteria.
(5) Generative AI-assisted design: The system uses prompt sentences constructed from structured data and transmits these to a generative AI model, then programmatically parses the output to derive structured proposals that are evaluated and integrated with optimization results. This closed-loop architecture is different from manual use of generative text tools, and it leverages machine-generated diversity of solutions in a controlled, machine-readable fashion to improve solution quality and adaptability.
(6) Continuous learning from feedback: The explicit capture and reuse of administrator feedback in model training and prompt construction enables the system to adapt to changing preferences and conditions over time. This improves convergence to effective strategies and reduces the need for manual recalibration.

### ALTERNATIVE EMBODIMENTS

In alternative embodiments, the server uses different machine learning architectures, such as temporal convolutional networks or graph neural networks that capture spatial relationships between areas. In yet another embodiment, the generative AI model is fine-tuned with domain-specific operation logs so that its outputs are more aligned with physical constraints.

In some embodiments, terminals do not transmit any raw media data but only feature vectors and combined emotion scores. In other embodiments, terminals may offload both feature extraction and raw media storage to the server when they are not resource-constrained, trading off communication cost against on-device computation.

In further embodiments, the server uses probabilistic models (for example, Bayesian networks) in conjunction with neural networks to quantify uncertainty in forecasts and to adjust optimization constraints accordingly.

In each of these embodiments, the core structure of integrating time-series environmental, equipment, and user-state information; computing a corrected emotion index; generating prompt sentences; cooperating with a generative AI model; and using optimization algorithms to produce operation measures remains consistent with the claimed invention. The result is a computer-implemented control system that not only automates complex decisions but also improves the technical behavior and performance of the underlying computing infrastructure in handling heterogeneous, real-time, and human-centered data.

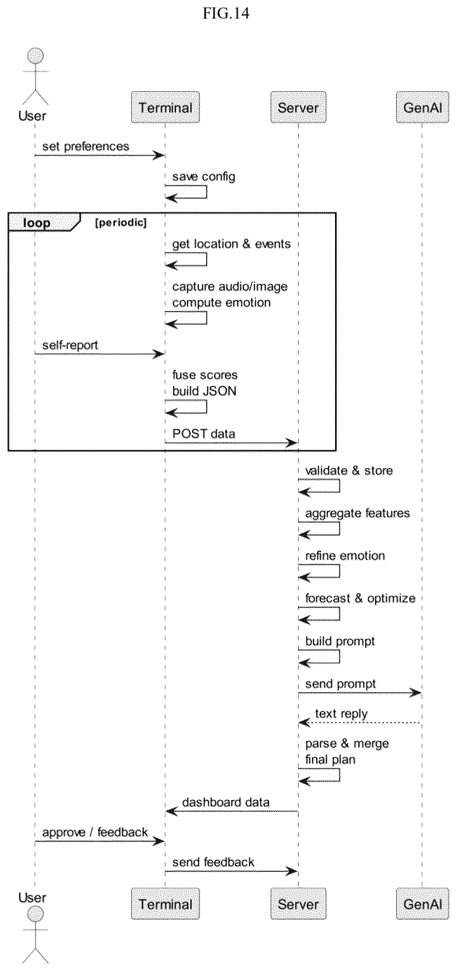

The following describes the processing flow using FIG. 14.

### Step 1:

User configures data sharing and privacy preferences on the terminal.

User reads terms and privacy information on the terminal's display and selects options such as whether to share audio, image, and location data, and what precision of location to allow.

Input: user taps and selections on checkboxes, sliders, and buttons shown by the application UI. Terminal converts these UI events into a configuration object containing flags (for example, share_audio, share_image, share_location) and parameters (for example, location_precision_level). Terminal serializes the configuration into a key-value structure or JSON and calls a secure storage API (for example, a protected preference store or keychain) to encrypt and save the configuration locally.

Output: encrypted configuration data stored on the terminal, accessible to later processing.

### Step 2:

Terminal acquires and preprocesses location information.

Terminal reads the saved configuration to check whether location acquisition is enabled and which precision level is permitted.

Input: raw position readings (latitude, longitude, timestamp, accuracy) from the operating system's location service.

Terminal applies a rounding or truncation operation to the latitude and longitude values according to the configured precision (for example, three decimal places for district-level granularity), and discards high-precision coordinates.

Terminal constructs a normalized location record including timestamp and rounded coordinates. Output: a rounded_location record suitable for area-level identification, with reduced precision for privacy.

### Step 3:

Terminal logs user operation history on the application.

Terminal registers listeners for screen lifecycle events and input events in the UI framework. Input: raw UI events such as “screen X appeared”, “button Y tapped”, and “input submitted”, each with a timestamp.

Terminal aggregates these events in an in-memory structure, incrementing tap counters and accumulating dwell times per screen.

Terminal, at fixed intervals (for example, every 5 minutes), performs a summarization computation, creating an activity_log list with entries that include screen identifiers, total tap_count per screen, and total or average duration per screen.

Output: a structured activity_log summarizing user interactions over a defined time window.

### Step 4:

Terminal acquires audio segments and computes first-stage audio emotion features.

Terminal checks whether the configuration allows audio-based emotion analysis. If allowed, terminal periodically starts a short recording using the microphone API.

Input: raw audio waveform samples (for example, 16 kHz PCM) captured during a recording window.

Terminal partitions the waveform into short overlapping frames, and for each frame computes DSP features such as frame energy, fundamental frequency, and spectral centroid.

Terminal then aggregates frame-level features over the window, computing averages or other statistics to obtain a fixed-length audio feature vector.

Terminal passes this feature vector into a small neural network classifier or logistic regression model deployed on the device. The model performs matrix multiplications and activation functions to produce a probability distribution over predefined audio-emotion classes.

Terminal selects the class with the highest probability as an audio-based emotion label and uses that probability as audio_emotion_score.

Output: audio_emotion_label and audio_emotion_score derived from the recorded audio segment.

### Step 5:

Terminal acquires facial images and computes first-stage facial emotion features.

Terminal checks whether camera-based emotion analysis is permitted and whether the application is in a suitable foreground state.

Input: video frames from the front camera, obtained via the camera capture API.

Terminal provides each frame to a face detection library, which returns bounding boxes for detected faces. The terminal crops and resizes each face region to the input size expected by the facial expression model.

Terminal runs the pre-processed face image through an on-device neural network (for example, a convolutional model) using a mobile inference runtime. The network performs convolution, pooling, and fully connected layer computations, outputting probabilities for facial expression categories.

Terminal selects the class with maximum probability as face_emotion_label and uses that probability as face_emotion_score; optionally terminal averages probabilities over multiple frames to stabilize the estimate.

Output: face_emotion_label and face_emotion score representing facial expression-based emotion.

### Step 6:

Terminal fuses sensor-based emotion scores with user self-report.

Terminal presents a self-report interface prompting the user to rate current mood on a discrete scale (for example, 1-5).

Input: audio_emotion_score, face_emotion_score (if available), and a self_reported_mood value entered by the user.

Terminal computes a sensor_score based on available sensor scores, for example by averaging audio_emotion_score and face_emotion_score or using a weighted sum.

Terminal normalizes self_reported_mood to a [0,1] range (for example, divide by 5), and then calculates a combined emotion score according to a defined formula: combined_score=α×sensor_score+(1×α)×normalized_self_report.

Terminal chooses an overall emotion_label based on a selection rule (for example, the sensor modality with the highest confidence).

Output: emotion_label and emotion_score_combined, representing a fused emotion metric to be transmitted to the server.

### Step 7:

Terminal constructs a data packet and transmits it securely to the server.

Terminal gathers all locally prepared information for a given interval.

Input: rounded_location from Step 2, activity_log from Step 3, emotion label and emotion_score_combined from Step 6, optional raw or intermediate emotion scores, and a device or user token.

Terminal places these values into a JSON object conforming to the server's input schema, converting in-memory structures to serializable fields.

Terminal attaches an authentication token in the HTTP header and sends an HTTPS POST request to the server's ingestion endpoint using a network client library.

Output: an HTTP request containing the structured JSON payload, delivered to the server for further processing.

### Step 8:

Server receives, validates, and normalizes incoming data from terminals.

Server uses its web server and application framework to accept the HTTPS request.

Input: JSON payload containing user_token or device identifier, timestamp, location coordinates, activity_log, emotion_label, and emotion_score_combined.

Server parses the JSON into an internal object and verifies the presence and types of required fields. Server checks numeric ranges (for example, ensuring scores lie in [0,1]) and timestamp format, and rejects or logs anomalous records.

Server applies a hashing function to the user_token to derive a user_hash, which serves as an anonymized identifier. Server optionally calls a reverse-geocoding service with the rounded coordinates to determine an area_id.

Server constructs a normalized database record with fields such as time, area_id, user_hash, emotion_label, emotion_score, self_reported_mood, and activity_log.

Output: validated, normalized records ready for insertion into time-series storage.

### Step 9:

Server stores time-series records and maintains integrated feature views.

Server uses its database engine to persist the normalized records.

Input: normalized emotion-related records from Step 8 and additional records from infrastructure sensors, weather feeds, and energy-market APIs.

Server issues insert commands to append each record to the appropriate table (for example, emotion logs, energy usage, traffic state, environment state, weather, and energy market).

Server periodically or on demand executes aggregation queries that group records by area_id and fixed time buckets, computing averages and sums for key metrics.

Server maintains or refreshes a city_state_features view that exposes, for each (time bucket, area) pair, a feature vector including energy metrics, traffic metrics, environmental metrics, and average emotion indices.

Output: persistent time-series tables and a queryable integrated feature view suitable for model input and reporting.

### Step 10:

Server refines emotion indices using high-capacity models.

Server optionally loads de-identified audio features or short waveforms from storage, together with terminal-computed emotion scores.

Input: feature-level data and initial emotion_score_combined values associated with specific records.

Server feeds the feature data into a server-side deep model (for example, a convolutional or transformer-based neural network) that has been trained on large emotion-labeled datasets. The model computes refined emotion estimates by executing multiple layers of linear transformations and nonlinear activations.

Server combines the model's refined output with the terminal's combined score using a calibration function or a shallow calibration network. The calibration module takes the initial and refined scores as input features and outputs a corrected emotion index that minimizes prediction error against training labels.

Server updates the corresponding emotion_log records with the corrected emotion index. Output: a corrected emotion index stored in the database, improving the reliability of emotion-related data.

### Step 11:

Server predicts future demand and emotion trends.

Server runs its analytics component to prepare input sequences for forecasting.

Input: feature vectors from the city_state_features view, organized by area and chronological order. Server constructs time windows (for example, sequences of the most recent N intervals) for each area, normalizes features (for example, subtracting mean and dividing by standard deviation), and passes these sequences to a forecasting model such as a recurrent neural network or gradient-boosted trees.

Server performs model inference, computing predicted values for future power consumption, traffic volume, and emotion indices for selected horizons.

Server writes predictions to forecast tables or caches them in memory for downstream optimization. Output: demand forecasts and emotion forecasts per area and future interval.

### Step 12:

Server computes multi-objective operation plans through optimization.

Server collects forecasted data and current constraints for controlled equipment.

Input: predicted power demand, predicted traffic volume, predicted emotion indices, current energy prices, equipment limits, and policy constraints.

Server formulates an optimization problem by defining a set of decision variables (for example, brightness levels, HVAC setpoint adjustments, transport frequency multipliers) and objective terms (for example, total energy cost, weighted discomfort based on emotion indices).

Server encodes constraints such as physical capacity, safety requirements, and minimum quality-of-service levels, and then passes the objective and constraints to a mathematical solver.

Server runs the solver, which performs iterative numeric computations (for example, simplex or branch-and-bound) to find variable assignments that minimize the objective.

Server interprets the solver's solution as an operation plan with concrete control values for each area and time bucket.

Output: a structured operation plan specifying recommended control parameters to balance energy efficiency and user emotion.

### Step 13:

Server generates a prompt sentence and queries a generative AI model for proposals. Server selects salient statistics and portions of the operation plan that should be reviewed or refined.

Input: aggregated metrics (for example, average power consumption and emotion scores per area), forecast data, and operation plan details from Step 12.

Server converts numeric values into natural language descriptions and assembles them into a coherent text. The server appends explicit instructions requesting proposals, design ideas, or justifications.

For example, the server may generate the following prompt sentence:

“Using the following city data, propose an operation policy that considers both energy efficiency and user emotions.

Area A: average power consumption 1200 kW, average emotion score 0.45 (high stress)

Area B: average power consumption 900 kW, average emotion score 0.80 (comfortable) Current electricity price: 30 currency units per kWh

Tomorrow's temperature forecast: high 35 degrees, low 27 degrees

Please present concrete adjustment measures for lighting, air conditioning, and public transport operations that will reduce peak energy consumption while improving Area A's emotion score to at least 0.60.”

Server sends this prompt sentence to a generative AI model via an API, specifying generation parameters such as maximum length and sampling strategy.

Output: a prompt sentence transmitted to the generative AI model and a generated text response containing proposed measures and design suggestions.

### Step 14:

Server parses generative AI output and integrates it with the optimization result.

Server receives a text response from the generative AI model.

Input: natural language text describing suggested changes, such as “reduce lighting by 20% in Area A between 18:00 and 21:00 and increase bus frequency by 15%.”

Server applies parsing logic, such as regular expressions and simple natural language parsing, to extract structured fields (for example, target area, control type, magnitude, time window) from the text.

Server compares the extracted proposals with the existing operation plan, checking for conflicts and constraint violations. If appropriate, server creates alternative or augmented operation measures by merging or adjusting the optimization output according to the generative suggestions, possibly re-evaluating cost and emotion impacts.

Output: a refined or augmented set of operation measures that reflect both optimization-based decisions and generative AI proposals.

### Step 15:

Server prepares visualization data and sends it to management terminals.

Server compiles an overview of the current state, forecasted values, and proposed operation measures for each area.

Input: operation measures from Step 14, historical and predicted metrics, and corrected emotion indices.

Server formats these data into structured responses for dashboard consumption, including map data (area shapes and emotion indices), time-series arrays, and tabular lists of measures with expected effects (for example, predicted reduction in peak power and increase in emotion score). Server exposes this information through web API endpoints and returns JSON responses to requests from management terminals.

Output: structured dashboard data transmitted to management terminals for visualization.

### Step 16:

Terminal (management terminal) displays dashboards and collects administrator decisions. Terminal uses its web browser and client-side scripts to render the received data.

Input: map data, time-series data, and lists of operation measures received from the server. Terminal draws a map view where areas are colored by emotion index or energy usage, plots graphs showing historical and predicted metrics, and displays tables listing each proposed measure and its expected impact.

User reviews the displays and interacts with the dashboard, approving, modifying, or rejecting specific measures, and optionally entering feedback comments about perceived comfort or risks. Terminal converts these actions into structured feedback objects that reference measure identifiers and contain status flags and comments, and transmits them back to the server via HTTPS. Output: administrator feedback records returned to the server, enabling continuous refinement of the system's models and control strategies.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

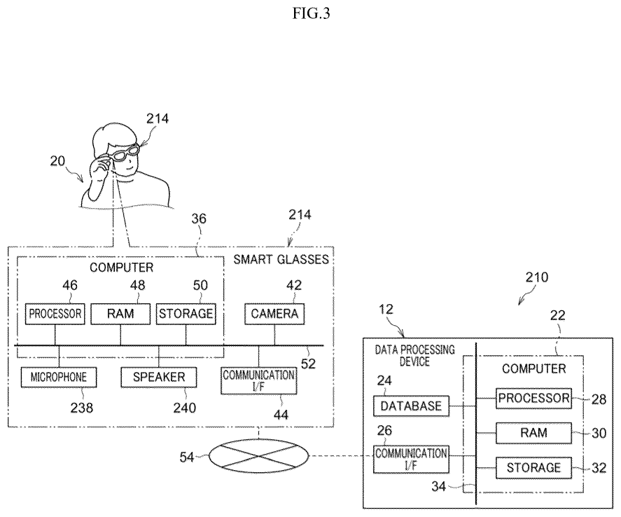

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

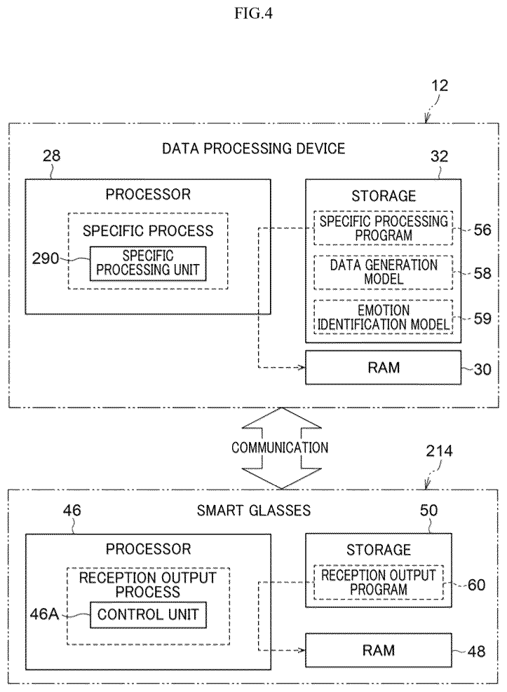

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

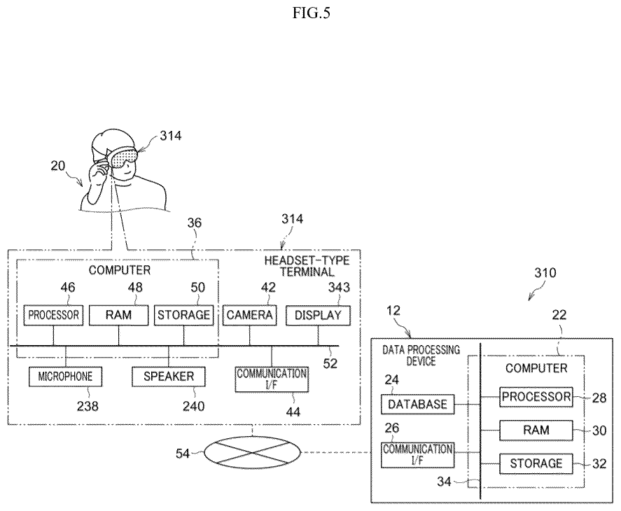

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

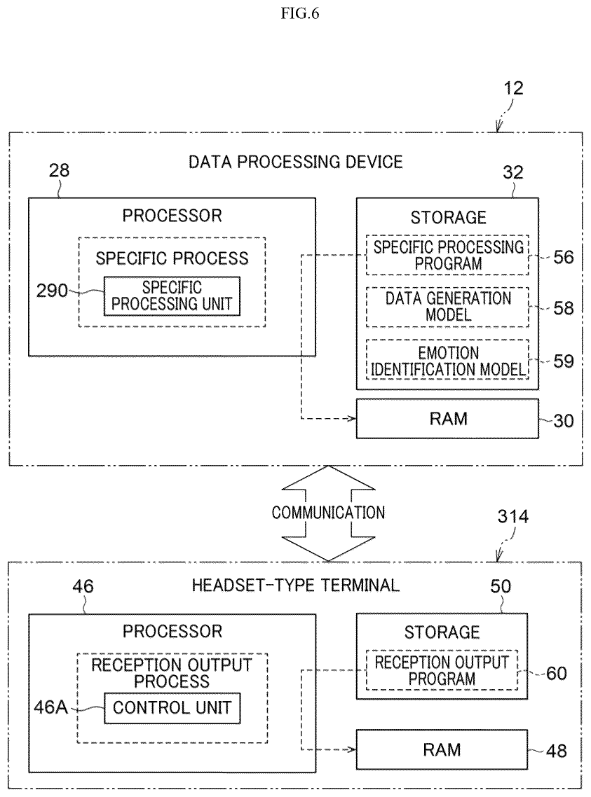

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

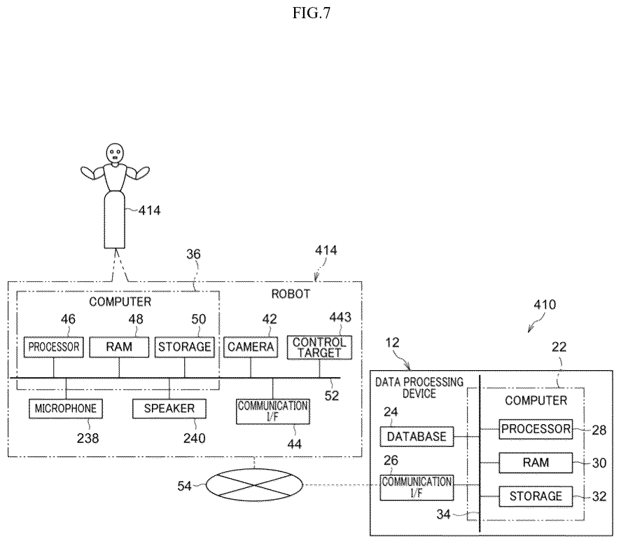

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

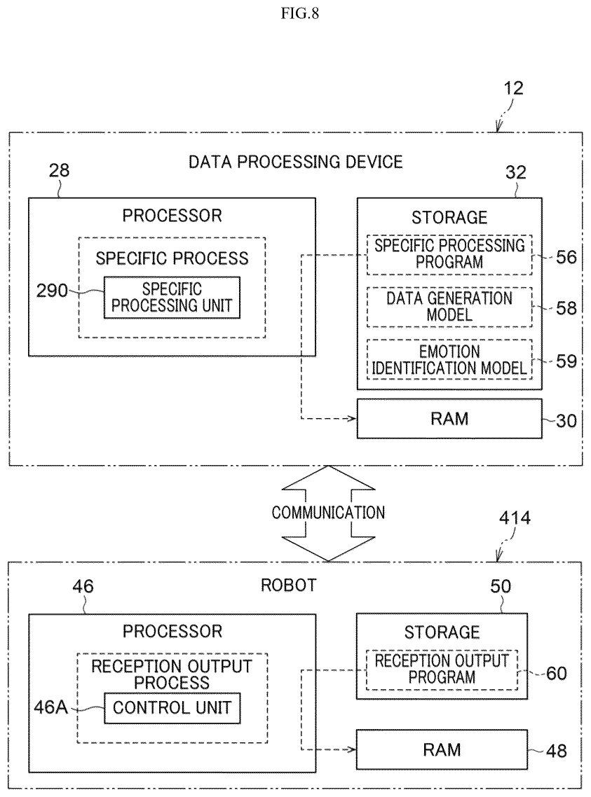

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

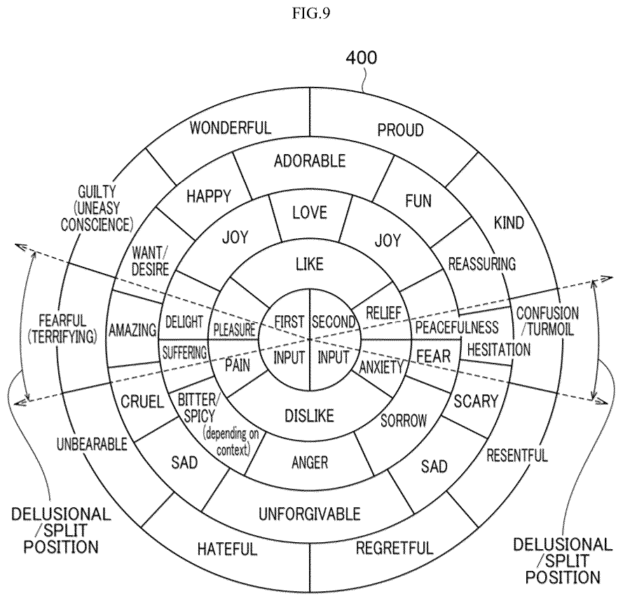

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379:“Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

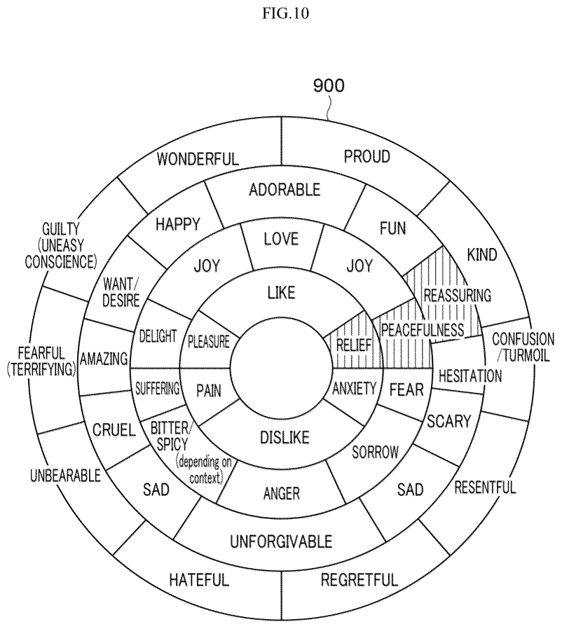

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

receive, via a communication network, environmental information including temperature information, humidity information, power information, flow information, and pressure information from one or more information acquisition devices in a facility, validate the environmental information based on identification information and time information included in the environmental information, remove abnormal values from the environmental information, standardize the environmental information, and store the standardized environmental information as time-series information in a recording information storage, and

acquire, via the communication network, external information including weather information and price information from one or more external information providing devices, align the external information with the time-series information on a common time axis, and store the external information in the recording information storage in an integrated manner with the time-series information, and

analyze, based on the time-series information, the weather information, and the price information stored in the recording information storage, future values of power consumption information and temperature information by performing statistical processing and machine learning processing, and numerically calculate operational conditions including operation conditions of cooling equipment and load distribution conditions of an information processing device group, and generate, based on the time-series information, the operational conditions, the weather information, and the price information, explanatory information summarizing a current and predicted operational state, generate a natural-language instruction sentence from the explanatory information, and construct inquiry information including the instruction sentence as a prompt sentence to be input to a generative information processing model, and obtain, from the generative information processing model, operational policy information expressed in natural language in response to the prompt sentence, compare the numerically calculated operational conditions with the operational policy information, determine consistency between the numerically calculated operational conditions and the operational policy information based on safety conditions and constraint conditions, and generate integrated operational conditions by correcting or invalidating conflicting operational conditions, and generate display information including the integrated operational conditions and the operational policy information, and transmit the display information to a user terminal, and receive, from the user terminal, operation information indicating acceptance or modification of the integrated operational conditions, and, based on the operation information, output control information corresponding to the integrated operational conditions to at least one of a building facility management device and a cooling facility control device, and store a result of the output control information as history information in the recording information storage.

### (Supplementary 2)

The system according to supplementary 1,

wherein the processor is configured to

generate, as the prompt sentence, an instruction sentence in natural language including condition information comprising past environmental information, prediction information derived from the past environmental information, a predetermined upper limit temperature value, and an allowable power consumption amount, transmit the prompt sentence to the generative information processing model, obtain, from the generative information processing model, response information in natural language including, for each time period, setting values of the cooling equipment, load distribution of the information processing device group, and explanation information indicating reasons for satisfying the condition information, extract, from the response information, time information, setting value information, and the explanation information corresponding to the condition information, and reflect the extracted time information and setting value information in the integrated operational conditions.

### (Supplementary 3)

The system according to supplementary 1, wherein the processor is configured to

control the user terminal to display an input screen for inputting a prompt sentence including a free-description question sentence or instruction sentence in natural language by a user, receive the prompt sentence from the user terminal, transmit the prompt sentence to the generative information processing model, obtain response information from the generative information processing model, and transmit the response information to the user terminal such that the user terminal displays the response information in association with the input screen, thereby enabling the user to examine the operational conditions and create modification proposals of the operational conditions by using the generative information processing model.

### Application Example 1

### (Supplementary 1)

A system comprising a processor,

wherein the processor is configured to

acquire observation information regarding an environmental state and an energy usage state in an information processing facility from an observation device, and collect the observation information as time-series information, and

transmit the observation information via a communication network to an information storage area on a remote information processing device, and store the observation information as the time-series information after performing preprocessing including duplicate elimination and unit normalization, and

integrate the time-series information and external information including weather information and energy price information acquired from an external information providing device, and generate a feature set, and

construct, on the basis of the feature set, a prediction model that estimates, for future time points, at least one of energy demand, cooling load, and an operation index in the information processing facility by performing learning processing using a machine learning technique in a prediction processing device, and dynamically update the prediction model in accordance with new time-series information and new external information, and

calculate, on the basis of an estimation result of the prediction model and on controllable equipment operation conditions and operation constraint conditions in the information processing facility, an operation plan for minimizing at least one of energy consumption and operation cost, by executing optimization processing, and

generate situation information including the estimation result of the prediction model, the operation plan calculated by the optimization processing, and past operation history, summarize the situation information, generate a prompt sentence including the summary and an instruction sentence regarding an operation policy, input the prompt sentence to a generative information processing model, and cause the generative information processing model to generate natural language explanation information describing contents and grounds of the operation plan or to generate an alternative operation plan, and

convert the natural language explanation information and the operation plan into display information presentable on a display device, present the display information to an operation manager via a management display screen, receive approval information or adjustment instruction information from the operation manager, update the operation plan on the basis of the approval information or the adjustment instruction information, and generate control command information for an equipment control device in accordance with the updated operation plan, and change operation conditions of equipment including at least one of a cooling device, a power load device, and a traffic control device on the basis of the control command information, and collect a post-change operation state of the equipment again as the observation information, thereby continuously updating input information to the prediction model and to the generative information processing model through feedback control.

### (Supplementary 2)

The system according to supplementary 1,

wherein the processor is configured to

construct the prompt sentence by dividing the situation information including the estimation result of the prediction model, the operation plan calculated by the optimization processing, and abnormal event information extracted by abnormality detection processing, into constituent elements including at least background information, data outline, and requested task, input the prompt sentence to the generative information processing model, analyze the natural language explanation information obtained from the generative information processing model on the basis of the prompt sentence, extract, as structured information, at least one of candidate actions, execution time periods, target values, and expected effect amounts, and store the structured information in a format usable by at least one of the optimization processing and the management display screen.

### (Supplementary 3)

The system according to supplementary 1,

wherein the processor is configured to

in response to an input operation by the operation manager on the management display screen to change operation conditions including at least one of an allowable temperature range, load shift allowance, cost priority, and comfort priority with respect to the natural language explanation information and the structured information presented on the management display screen, acquire the changed operation conditions, generate, on the basis of new situation information including the changed operation conditions, a recalculation prompt sentence, input the recalculation prompt sentence to the generative information processing model to obtain recalculated explanation information or a recalculated recommendation, and calculate, by the optimization processing, a new operation plan reflecting the changed operation conditions.

### Example 2

### (Supplementary 1)

A system comprising a processor,

wherein the processor is configured to

acquire environment data including temperature, humidity, power consumption, and cooling equipment operation status from a plurality of measuring devices that measure physical quantities in a data center, add time information and device identification information to the acquired environment data, normalize the environment data, and sequentially store the normalized environment data in a storage device as environment data records,

acquire external environment data including weather information and energy price information from an external information providing apparatus via a communication line, convert the external environment data into time-series data that is associable with the environment data based on time information, and store the converted external environment data in the storage device as external environment data records,

perform time-direction resampling and statistical calculation on the environment data records and the external environment data records so as to generate a feature matrix representing energy consumption and cooling load, input the feature matrix into a prediction model based on a machine learning algorithm, and estimate future energy consumption, energy consumption peak times, and cooling load indices as prediction results,

acquire operation history data including input operation events, screen transition events, and error occurrence events on a management display apparatus, and natural language text input via the management display apparatus, calculate behavioral feature values from the operation history data, perform emotion analysis processing on the natural language text to calculate linguistic feature values, and input the behavioral feature values and the linguistic feature values into a classification model so as to estimate category information representing an emotional state of an operation manager,

generate explanation information summarizing an operating state and future predictions of the data center on the basis of the prediction results and the external environment data records, dynamically generate, according to the emotional state estimated by the classification model, a prompt sentence serving as an instruction sentence to be input to a generative AI model by switching a degree of summarization, an output format, and output conditions of the explanation information, input the prompt sentence into the generative AI model, acquire an operation proposal text relating to optimization of cooling and energy efficiency of the data center from the generative AI model, convert the operation proposal text into structured data including procedure information and scenario information, and store the structured data in the storage device as operation proposal records,

control, according to the emotional state estimated by the classification model, a presentation format, presentation content, and screen configuration of the operation proposal acquired from the generative AI model, such that, in a high-stress state, a small number of procedure information items with high importance are emphasized, and, in a normal state, comparison information of a plurality of scenarios and detailed analysis indices are simultaneously displayed, and change a display layout of the management display apparatus accordingly,

acquire scenario identification information and setting parameters selected by the operation manager on the basis of the presented operation proposal, verify that the setting parameters satisfy predetermined operation constraint conditions, generate and transmit control commands to at least one of a cooling equipment control system and a power management system, and record the control commands and execution results as control history data in the storage device, and reuse the control history data, and subsequently acquired environment data records, external environment data records, operation history data, and natural language text, as learning data in the prediction model and the classification model, and update parameters of the prediction model and the classification model to continuously improve prediction accuracy and emotional state estimation accuracy.

### (Supplementary 2)

The system according to supplementary 1,

wherein the processor is configured to, when the emotional state estimated by the classification model is determined to be a high-stress state, include, in the prompt sentence, a condition that requests the generative AI model to generate the operation proposal text in a concise procedure format with a limited maximum number of steps, and, when the emotional state estimated by the classification model is determined to be a normal state, include, in the prompt sentence, a condition that requests the generative AI model to generate the operation proposal text including comparison information of a plurality of operation scenarios and table-formatted cost information.

### (Supplementary 3)

The system according to supplementary 1, wherein the processor is configured to, when the emotional state estimated by the classification model is determined to be a high-stress state, set a screen configuration of the management display apparatus such that detailed historical graphs and a large number of setting items are hidden or folded and only procedure information with high urgency among the operation proposal text is enlarged and displayed, and, when the emotional state estimated by the classification model is determined to be a normal state, set a screen configuration of the management display apparatus such that comparison tables of a plurality of scenarios, time-series graphs, and operation parameter input portions are simultaneously displayed.

### Application Example 2

### (Supplementary 1)

A system comprising a processor,

wherein the processor is configured to

acquire time-series information relating to an environmental state, an equipment state, and a user state in a managed facility from one or more detection units,

store the acquired time-series information and external information including weather information and energy transaction information in a storage device as time-series records, and aggregate and integrate the stored time-series records on a time basis and an area basis to generate integrated feature data,

estimate a user emotion state based on audio information, image information, position information, operation history information, and self-report information acquired by one or more terminal devices, and calculate an emotion index by performing weighted integration of an estimation result of the user emotion state and the self-report information, execute machine learning processing and mathematical optimization processing using, as input, energy consumption information, environmental state information, traffic state information, the external information, and the emotion index stored in the storage device, and calculate a demand forecast and an operation plan that simultaneously take into account an energy efficiency index and the emotion index,

convert at least a part of the integrated feature data, the emotion index, and the operation plan into natural language text to generate a prompt sentence, input the prompt sentence into a generative artificial intelligence model, and acquire proposal information relating to at least one of the operation plan, a control parameter, and a display configuration,

integrate the operation plan calculated by the machine learning processing and the mathematical optimization processing with the proposal information acquired from the generative artificial intelligence model, determine operation measures including predicted changes of the energy efficiency index and the emotion index, and generate structured information representing the operation measures, and transmit the structured information to a management terminal, and cause an interface on the management terminal to visualize, based on the structured information, at least an energy usage situation, the emotion index, the operation measures, and predicted effects thereof for each area, accept an approval input, a modification input, and a feedback input from a user, and reflect the feedback input in at least one of the stored time-series records and parameters used in the machine learning processing.

### (Supplementary 2)

The system according to supplementary 1,

wherein the processor is configured to

execute a multi-stage emotion estimation process in which a terminal-side lightweight inference process calculates a first-stage emotion score from audio features and facial expression features, performs numerical computation according to a predetermined weighting expression on the first-stage emotion score and a self-report evaluation value to generate an integrated emotion score, and a server-side high-accuracy trained model computes an additional estimation result from the audio features, and the additional estimation result and the integrated emotion score are fused again to output a corrected emotion index.

### (Supplementary 3)

The system according to supplementary 1,

wherein the processor is configured to

summarize statistical information including at least the integrated feature data, the corrected emotion index, past operation measures, and user feedback corresponding to the past operation measures, generate the prompt sentence based on the summarized statistical information, input the prompt sentence repeatedly into the generative artificial intelligence model to obtain a plurality of candidate proposals relating to at least one of operation logic, the control parameter, and a management screen configuration, and compare the plurality of candidate proposals with a result of the mathematical optimization processing to select an adopted proposal.

What is claimed is:

1. A system comprising:
circuitry configured to:
receive, via a communication interface coupled to a packet-switched network, time-series sensor data from a plurality of sensor devices deployed in a facility, the time-series sensor data including at least temperature values, humidity values, and power consumption values;
store the time-series sensor data in a storage device coupled to the packet-switched network;
acquire external condition data from at least one external data source coupled to the packet-switched network and align the external condition data with the time-series sensor data on a common time axis;
analyze the time-series sensor data and the external condition data using a machine learning model to generate predicted state data representing future values of at least power consumption and temperature;
construct a prompt data structure encoding the time-series sensor data, the predicted state data, and the external condition data, transmit the prompt data structure to a generative neural network model, and receive operational policy data from the generative neural network model;
compare the predicted state data with the operational policy data against constraint parameters to generate integrated control data; and
transmit the integrated control data to at least one of a terminal device and a facility control device via the communication interface.

2. The system according to claim 1, wherein the time-series sensor data further includes airflow rate values and pressure values associated with cooling paths within the facility, and wherein each data point of the time-series sensor data includes an identification code of the respective sensor device and a timestamp.

3. The system according to claim 2, wherein the circuitry validates the time-series sensor data by detecting abnormal values based on statistical deviation from a moving average computed over a sliding window, removes the detected abnormal values, and standardizes the validated time-series sensor data by applying normalization to a common scale before storing the standardized time-series sensor data in the storage device.

4. The system according to claim 3, wherein the circuitry generates a spatial thermal distribution map by interpolating the standardized temperature values across sensor positions within the facility and identifies localized thermal anomaly regions where interpolated temperature values exceed a threshold derived from the moving average.

5. The system according to claim 1, wherein the external condition data includes weather forecast data and time-varying pricing data, and wherein the circuitry aligns the external condition data with the time-series sensor data by resampling the external condition data to match a sampling interval of the time-series sensor data and joining the resampled external condition data with the time-series sensor data on corresponding timestamps.

6. The system according to claim 5, wherein the machine learning model comprises a recurrent neural network or a temporal convolutional network trained on the time-series sensor data and the external condition data to predict the future values of power consumption and temperature over a prediction horizon, and wherein the circuitry periodically retrains the machine learning model using newly accumulated time-series sensor data stored in the storage device.

7. The system according to claim 6, wherein the circuitry further uses the predicted state data to numerically compute load distribution parameters specifying allocation of computational workload across a plurality of processing devices in the facility, and cooling equipment operation parameters specifying at least one of fan speed, coolant flow rate, and compressor duty cycle.

8. The system according to claim 1, wherein the prompt data structure includes a structured text sequence comprising a plurality of field identifiers, each field identifier associated with a respective data value derived from the time-series sensor data, the predicted state data, and the external condition data, and wherein the generative neural network model comprises a transformer-based architecture including an embedding layer, a plurality of self-attention layers, and an output projection layer.

9. The system according to claim 8, wherein the circuitry compares the predicted state data with the operational policy data by evaluating each element of the operational policy data against the constraint parameters including safety threshold values and equipment operating range values, and generates the integrated control data by retaining elements of the operational policy data that are consistent with the constraint parameters and replacing inconsistent elements with corresponding values from the predicted state data.

10. The system according to claim 9, wherein the circuitry generates explanatory data describing a rationale for each retained or replaced element in the integrated control data and transmits the explanatory data together with the integrated control data to the terminal device for display.

11. The system according to claim 1, wherein the circuitry is further configured to receive, via the communication interface, user input data from the terminal device including at least one of text data representing a natural-language instruction and selection data indicating acceptance or modification of the integrated control data, and to update the prompt data structure based on the user input data and retransmit the updated prompt data structure to the generative neural network model.

12. The system according to claim 11, wherein the circuitry converts the natural-language instruction into machine-interpretable constraint data using a natural language processing model, incorporates the machine-interpretable constraint data into the constraint parameters, and regenerates the integrated control data using the updated constraint parameters.

13. The system according to claim 1, wherein the circuitry transmits the integrated control data as control command packets to the facility control device via the communication interface, the control command packets specifying at least one of a cooling equipment setpoint, a fan speed value, and a load distribution parameter, and stores a record associating the integrated control data with a timestamp and the corresponding time-series sensor data in the storage device as history data.

14. The system according to claim 13, wherein the circuitry analyzes the history data to compute an effectiveness metric comparing predicted state data with actual sensor data received after execution of control commands, and uses the effectiveness metric to adjust at least one of the machine learning model parameters and the constraint parameters.

15. The system according to claim 1, wherein the circuitry is further configured to:
receive, via the communication interface, at least one of interaction log data and text input data from the terminal device; and
estimate a cognitive load state of an operator based on the interaction log data and the text input data using an estimation model.

16. The system according to claim 15, wherein the circuitry adjusts a level of detail of the integrated control data transmitted to the terminal device based on the estimated cognitive load state, including transmitting a simplified summary when the estimated cognitive load state exceeds a threshold and transmitting a detailed breakdown when the estimated cognitive load state is below the threshold.

17. The system according to claim 16, wherein the circuitry further adjusts the prompt data structure based on the estimated cognitive load state to include a conciseness constraint when the estimated cognitive load state exceeds the threshold, causing the generative neural network model to generate shorter operational policy data.

18. A system comprising:
a communication interface including a network interface controller coupled to a packet-switched network and configured to transmit and receive data packets;
a memory storing instructions, a machine learning prediction model comprising at least one of a recurrent neural network and a temporal convolutional network, a generative neural network model comprising an embedding layer, a plurality of self-attention layers, and an output projection layer, and constraint parameters; and
circuitry comprising one or more processors coupled to the memory and configured to execute the instructions to:
receive, via the communication interface, time-series sensor data from a plurality of sensor devices deployed in a facility, validate the time-series sensor data by detecting and removing abnormal values, and store standardized time-series sensor data in a storage device coupled to the packet-switched network;
acquire external condition data including weather forecast data and time-varying pricing data from at least one external data source via the communication interface and align the external condition data with the standardized time-series sensor data on a common time axis;
input the standardized time-series sensor data and the aligned external condition data to the machine learning prediction model to generate predicted state data representing future values of power consumption and temperature;
construct a prompt data structure encoding the standardized time-series sensor data, the predicted state data, and the external condition data as a structured text sequence, and transmit the prompt data structure to the generative neural network model to receive operational policy data;
compare the predicted state data with the operational policy data against the constraint parameters including safety threshold values and equipment operating range values, and generate integrated control data by retaining consistent elements and replacing inconsistent elements;
transmit the integrated control data to at least one of a terminal device and a facility control device via the communication interface; and
store a record associating the integrated control data with a timestamp and corresponding sensor data in the storage device.

19. The system according to claim 18, wherein the circuitry is further configured to receive user input data from the terminal device via the communication interface, convert a natural-language instruction included in the user input data into machine-interpretable constraint data, incorporate the machine-interpretable constraint data into the constraint parameters, and regenerate the integrated control data using the updated constraint parameters.

20. A method performed by circuitry of a server coupled to a packet-switched network via a communication interface, the method comprising:
receiving, via the communication interface, time-series sensor data from a plurality of sensor devices deployed in a facility, the time-series sensor data including at least temperature values, humidity values, and power consumption values;
storing the time-series sensor data in a storage device coupled to the packet-switched network;
acquiring external condition data from at least one external data source coupled to the packet-switched network and aligning the external condition data with the time-series sensor data on a common time axis;
analyzing the time-series sensor data and the external condition data using a machine learning model to generate predicted state data representing future values of at least power consumption and temperature;
constructing a prompt data structure encoding the time-series sensor data, the predicted state data, and the external condition data, transmitting the prompt data structure to a generative neural network model, and receiving operational policy data from the generative neural network model;
comparing the predicted state data with the operational policy data against constraint parameters to generate integrated control data; and
transmitting the integrated control data to at least one of a terminal device and a facility control device via the communication interface.
